(19) United States
(12) Patent Application Publication
(10) Pub. No.: US 2025/0310808 A1
(43) Pub. Date: Oct. 2, 2025

(54) METHODS, COMMUNICATIONS DEVICES AND INFRASTRUCTURE EQUIPMENT

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/864,900

(22) PCT Filed: Apr. 12, 2023
(86) PCT No.: PCT/EP2023/059551

§ 371 Date: Nov. 12, 2024

(30) Foreign Application Priority Data
May 24, 2022 (EP) 22175213.2

(51) Int. Cl. H04W 24/10; H04B 17/318; H04W 36/28

(52) U.S. Cl. CPC H04W 24/10; H04B 17/328; H04W 36/28

(57) ABSTRACT

Operating a device for multi-path handover from source infrastructure equipment and relay device to target infrastructure equipment and relay device includes receiving, from the source infrastructure equipment, a measurement configuration including conditions for triggering the device to transmit a measurement report to the source infrastructure equipment. The conditions are based on qualities of wireless links between the device and the source infrastructure equipment and between the device and the source relay device. Based on the measurements, the condition for triggering the device is determined to be met. The measurement report is transmitted to the source infrastructure equipment, and includes the measurements of the qualities of the wireless links. From the source infrastructure equipment, an instruction to perform the multi-path handover from the source infrastructure equipment and source relay device to the target infrastructure equipment and target relay device is received. Then the multi-path handover is performed.

### BACKGROUND

### Field

The present disclosure relates to communications devices, infrastructure equipment and methods of operating communications devices and infrastructure equipment to perform a multi-path handover and/or a multipath connection set-up.

The present application claims the Paris Convention priority from European Patent Application number EP22175213.2, filed on 24 May 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention. Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to support efficiently communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

### SUMMARY

The present disclosure can help address or mitigate at least some of the issues discussed above.

Example embodiments of the present technique can provide a method of operating a communications device to perform a multi-path handover from a source infrastructure equipment of a wireless communications network and a source relay communications device to a target infrastructure equipment of the wireless communications network and a target relay communications device. The method comprises receiving, from the source infrastructure equipment, a measurement configuration comprising a condition for triggering the communications device to transmit a measurement report to the source infrastructure equipment. The condition is based on a quality of a wireless communications link between the communications device and the source infrastructure equipment and a quality of a wireless communications link between the communications device and the source relay communications device. The method comprises determining, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met. The method comprises transmitting the measurement report to the source infrastructure equipment. The measurement report comprises an indication of the one or more measurements of the quality of the wireless communications link between the communications device and the source infrastructure equipment and the one or more measurements of the quality of the wireless communications link between the communications device and the source relay communications device. The method comprises receiving, from the source infrastructure equipment, an instruction to perform the multi-path handover from the source infrastructure equipment and source relay communications device to the target infrastructure equipment and target relay communications device. The method comprises performing the multi-path handover in accordance with the instruction received from the source infrastructure equipment.

Accordingly, example embodiments can provide support for multipath handovers involving both a direct and indirect link switch. The communications device can perform the link switch based on measurements of the quality of existing wireless communications links. For example, the communications device may perform the link switch when the quality of the existing wireless communications links deteriorates. Therefore, example embodiments can provide a communications device which maintains high quality wireless communications links for a direct and indirect path to infrastructure equipment of the wireless communications network. Therefore, as will be explained in more detail below, example embodiments can provide increased throughput and data transmission reliability in a wireless communications network.

Other example embodiments of the present technique can provide a method of operating a communications device to form a multipath connection to a first infrastructure equipment of a wireless communications network and a relay communications device controlled by a second infrastructure equipment of the wireless communications network. The method comprises receiving, from the first infrastructure equipment over a wireless communications link between the communications device and the first infrastructure equipment, a measurement configuration comprising a condition for triggering the communications device to transmit a measurement report to the first infrastructure equipment. The condition is based on a quality of a wireless communications link to be formed between the communications device and the relay communications device. The method comprises determining, based on one or more measurements of a quality of the wireless communications link to be formed between the communications device and the relay communications device, that the condition for triggering the communications device to transmit the measurement report has been met. The method comprises transmitting the measurement report to the first infrastructure equipment. The measurement report comprising an indication of the one or more measurements of the quality of the wireless communications link to be formed between the communications device and the relay communications device. The method comprises receiving, from the first infrastructure equipment, an instruction to form the wireless communications link with the relay communications device. The method comprises forming the wireless communications link with the relay communications device.

Accordingly, example embodiments can provide support for a multipath connection to an infrastructure equipment of a wireless communications network and a relay communications device controlled by a different infrastructure equipment of the wireless communications network. Therefore, as will be explained in more detail below, example embodiments can provide increased throughput and data transmission reliability in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment, communications device and relay communications device which may be configured to operate in accordance with certain embodiments of the present disclosure;

FIG. 4A schematically represents an example of an indirect-to-direct handover;

FIG. 4B illustrates an example of communications procedure for an indirect-to-direct handover;

FIG. 5A schematically represents an example of a direct-to-indirect handover;

FIG. 5B illustrates a communications procedure for a direct-to-indirect handover;

FIG. 6 schematically represents an example of an indirect-to-indirect handover for a multipath UE;

FIG. 7 schematically represents another example of an indirect-to-indirect handover for a multipath UE;

FIG. 8 schematically represents an example of an direct-to-direct handover for a multipath UE;

FIG. 9 schematically represents an example of a multipath handover for a multipath UE in accordance with example embodiments;

FIG. 10A schematically represents another example of a multipath handover for a multipath UE in accordance with example embodiments;

FIG. 10B schematically represents another example of a multipath handover for a multipath UE in accordance with example embodiments;

FIG. 11 is a flow diagram illustrating a method of operating a communications device to perform a multi-path handover in accordance with example embodiments;

FIG. 12A illustrates an example of a communications procedure for a multipath handover in accordance with example embodiments;

FIG. 12B illustrates an example of a communications procedure for a multipath handover in accordance with example embodiments;

FIG. 12C illustrates an example of a communications procedure for a multipath handover in accordance with example embodiments;

FIG. 13 is a flow diagram illustrating a method of operating a communications device to form a multipath connection setup in accordance with example embodiments;

FIG. 14 schematically represents an example of a multipath connection set-up in accordance with example embodiments;

FIG. 15 illustrates an example of a communications procedure for a multipath connection setup in accordance with example embodiments.

### DETAILED DESCRIPTION OF THE EMBODIMENTS

### Long Term Evolution Advanced Radio Access Technology (4G)

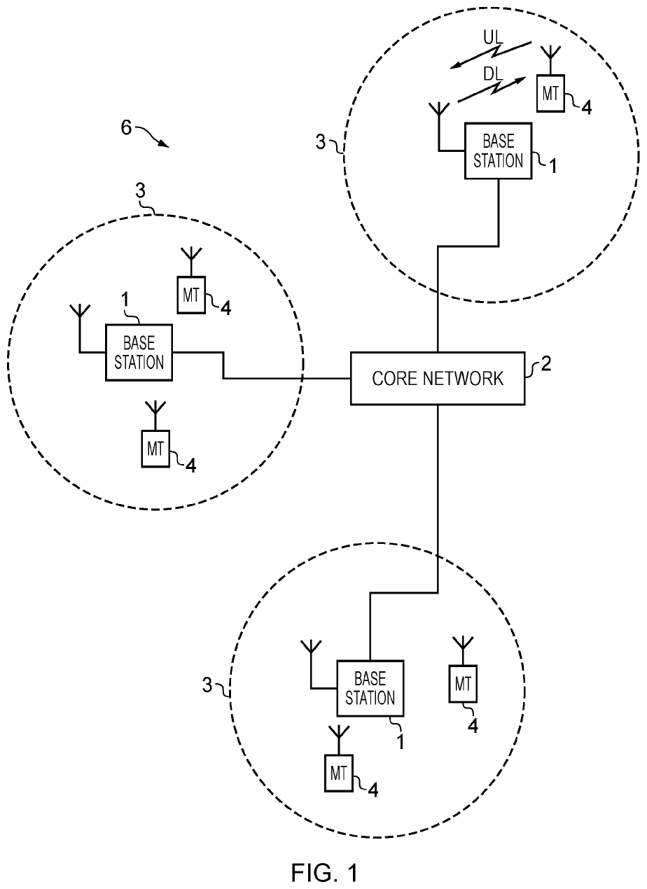

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

3GPP has completed the basic version of 5G in Rel-15, known as the New Radio Access Technology (NR). In addition, enhancements have been made in Rel-16, incorporating new features such as the 2-45 step RACH procedure [2], Industrial Internet of Things (IIoT) [3] and NR-based Access to Unlicensed Spectrum (NR-U) [4].

The NR radio access system employs Orthogonal Frequency Division Multiple Access (OFDMA), where different users are scheduled in different subsets of sub-carriers simultaneously. However, OFDMA requires tight synchronisation in the uplink transmissions in order to achieve orthogonality of transmissions from different users. In essence, the uplink transmissions from all users must arrive at the same time (i.e. they must be synchronised) at the gNB receiver. A UE that is far from the gNB must therefore transmit earlier than a UE closer to the gNB, due to different RF propagation delays. In NR, timing advance commands are applied to control the uplink transmission timing for individual UEs, mainly for Physical Uplink Shared Channels (PUSCHs), Physical Uplink Control Channels (PUCCHs) and Sounding Reference Signals (SRS). The timing advance usually comprises twice the one-way propagation delay between the UE and gNB, thus representing both downlink and uplink delays.

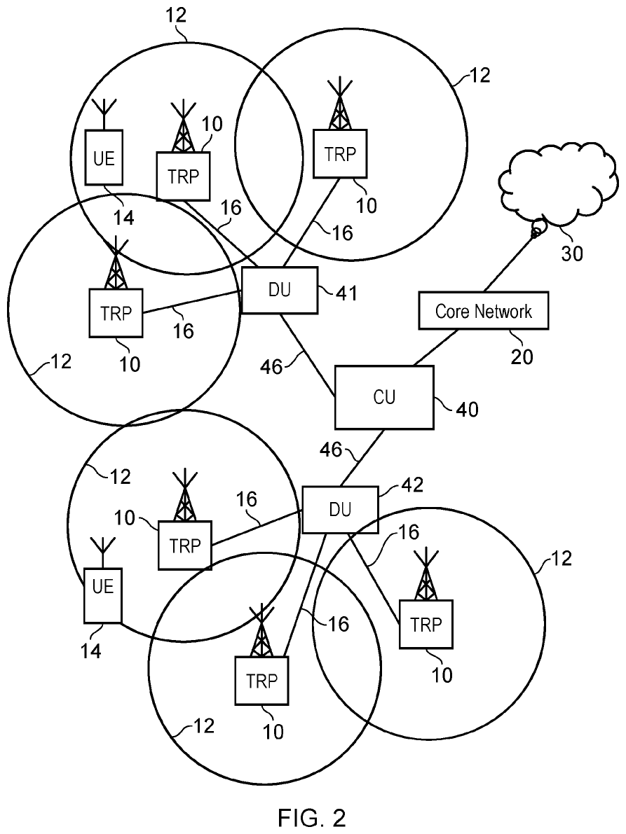

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a physical interface represented as a line 16. Each of the TRPs 10 is arranged to transmit and receive signals via a wireless access interface (i.e. a radio interface for wireless access) within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an F1 interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 42 and/or a TRP 10 of the kind shown in FIG. 2 which is adapted to provide functionality in accordance with the principles described herein.

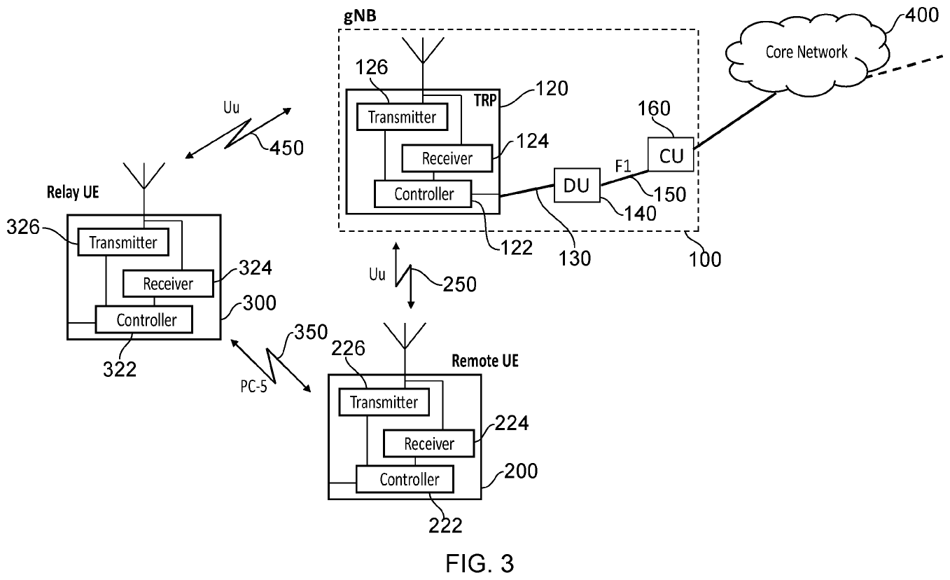

A more detailed diagram of some of the components of the network shown in FIG. 2 is provided by FIG. 3. In FIG. 3, a TRP 120, which broadly corresponds to TRP 10 in FIG. 2, comprises, as a simplified representation, a transmitter 126, a receiver 124 and a controller or controlling processor 122 which may operate to control the transmitter 126 and the receiver 124 to transmit and receive radio signals to one or more UEs within a cell (not shown in FIG. 3 for clarity) provided by the TRP 120.

As shown in FIG. 3, the TRP 120 is connected to a DU 140 via a physical interface 130 which may be a fibre optic cable, for example. The physical interface 130 therefore provides a communications link for data and signalling traffic from the TRP 210 via the DU 140 and a CU 160 to a core network 400. An interface 150 between the DU 140 and the CU 160 is known as the F1 interface which can be a physical or a logical interface. The F1 interface 150 between the DU 140 and the CU 160 may operate in accordance with specifications 3GPP TS 38.470 and 3GPP TS 38.473, and may be formed from a fibre optic or other wired or wireless high bandwidth connection. The connection between a TRP 210 and the core network 400 can be generally referred to as a backhaul, which comprises the physical interface 130 from the TRP 120 to the DU 140 and the F1 interface 150 from the DU 140 to the CU 160.

As shown in FIG. 3, the TRP 120 may be configured to transmit downlink radio signals and receive uplink radio signals from a remote UE 200 over a direct wireless communications link 250 to the remote UE 200. The direct wireless communications link 250 may be a Uu interface in one example. The remote UE 200 is shown to include a transmitter 226, a receiver 224 and a controller 222 which is configured to control the transmitter 226 and the receiver 224 to transmit uplink signals to the TRP 120 and to receive downlink signals from the TRP 120 over the wireless communications link 250 formed between the remote UE 200 and the TRP 120. When the remote UE 200 communicates with the TRP 120/gNB 100 over the direct wireless communications link 250 between the remote UE 200 and the TRP 120/gNB 100, the remote UE 200 can be said to be communicating with the TRP 120/gNB 100 via a “direct path”. A direct wireless communications link for a communications device (such as a UE) is to be construed as a wireless communications link to infrastructure equipment of a wireless communications network (such as a gNB) without intermediary wireless communications links (such as sidelink wireless communications links).

As shown in FIG. 3, the TRP 120 may be configured to transmit downlink radio signals and receive uplink radio signals from a relay UE 200 over a direct wireless communications link 450. The direct wireless communications link 450 may be a Uu interface in one example. The relay UE 300 is shown to include a transmitter 326, a receiver 324 and a controller 322 which is configured to control the transmitter 326 and the receiver 324 to transmit uplink signals to the TRP 120 and to receive downlink signals from the TRP 120 over the direct wireless communications link 450 formed between the relay UE 300 and the TRP 120.

As shown in FIG. 3, the controller 322 of the relay UE 300 may be configured to control the transmitter 326 to transmit downlink signals to the remote UE 200 over a sidelink wireless communications link 350 and to control the receiver 324 to receive uplink signals from the remote UE 200 over the sidelink wireless communications link 250. Similarly, the controller of the remote UE 200 may be configured to control the receiver 224 to receive downlink signals from the relay UE 300 and to control the transmitter 226 to transmit uplink signals to the relay UE 300. The sidelink wireless communications link 250 between the relay UE 300 and the remote UE 200 is a sidelink wireless communications link such as a PC-5 interface. Therefore, the relay UE 300 may be configured to relay signals between the remote UE 200 and the TRP 120. When the remote UE 200 is communicating with the TRP 120/gNB 100 via the relay UE 300 (that is, via the sidelink wireless communications link 250 between the remote UE 200 and the relay UE 300 and the direct wireless communications link 450 between the relay UE 300 and the TRP 120/gNB 100), the remote UE 200 can be said to be communicating with the gNB 100 via an “indirect path”. Although not shown in FIG. 3, an indirect path may further comprise one or more further relay UEs.

In the example shown in FIG. 3, since the relay UE 300 relays signals between the remote UE 200 and infrastructure equipment of the wireless communications network (i.e. the gNB 100), the relay UE 300 may be referred to as a “UE-to-Network (U2N)” relay. As will be appreciated by one skilled in the art, one or more other relay UEs may relay signals between the remote UE 200 and the relay UE 300 along the indirect path to the gNB 100, thereby acting as “UE-to-UE (U2U)” relays.

The transmitters 126, 226, 326 and the receivers 124, 224, 324 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 122, 222, 322 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s).

As shown in FIG. 3, the TRP 120, DU 140 and the CU 160 may collectively form a gNB 100 which is an example of infrastructure equipment of a wireless communications network. Therefore, references to the remote UE 200 or relay UE 300 communicating with the TRP 120 can alternatively be considered as references to the remote UE 200 or relay UE 300 communicating with the gNB 100. Furthermore, it will be appreciated that the remote UE 200 and the relay UE 300 are examples of communications devices. As will be appreciated the infrastructure equipment/TRP/base station/gNB as well as the UE/communications device will in general comprise various other elements associated with its operating functionality.

Therefore, as explained above, the remote UE 200 may communicate with the gNB 100 either via a direct path (i.e. via the direct wireless communications 250 link between the remote UE 200 and the gNB 100) or via an indirect path (i.e. via the sidelink wireless communications link 350 between the remote UE 200 and the relay UE 300 and the direct wireless communications link 450 between the relay UE 300 and the gNB 100). Conventionally, the remote UE 200 is configured at any one time to communicate either via the direct path or the indirect path but not both simultaneously. For example, the remote UE 200 may be configured to communicate via the direct path when the remote UE 200 is in the cell provided by the gNB 100. Alternatively, the remote UE 200 may be configured to communicate via the indirect path when the remote UE 200 is outside the cell provided by the TRP 120 but the relay CE 300 is inside the cell provided by the TRP 120. The relay UE 300 can thus provide coverage for the remote UE 200.

### Indirect-to-Direct Handover

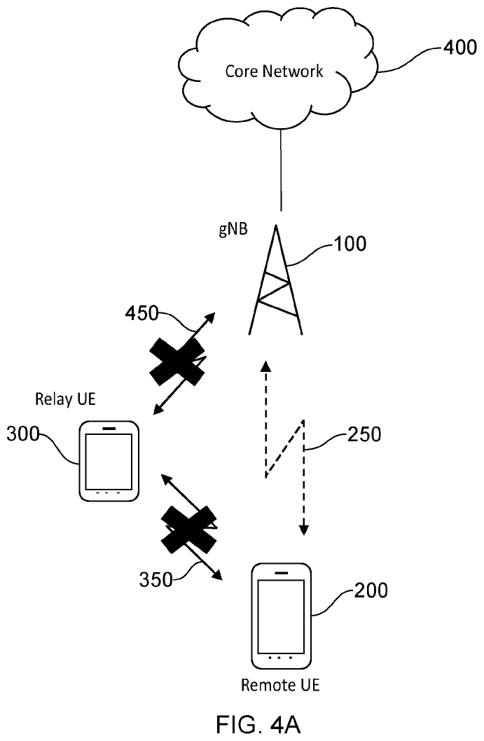

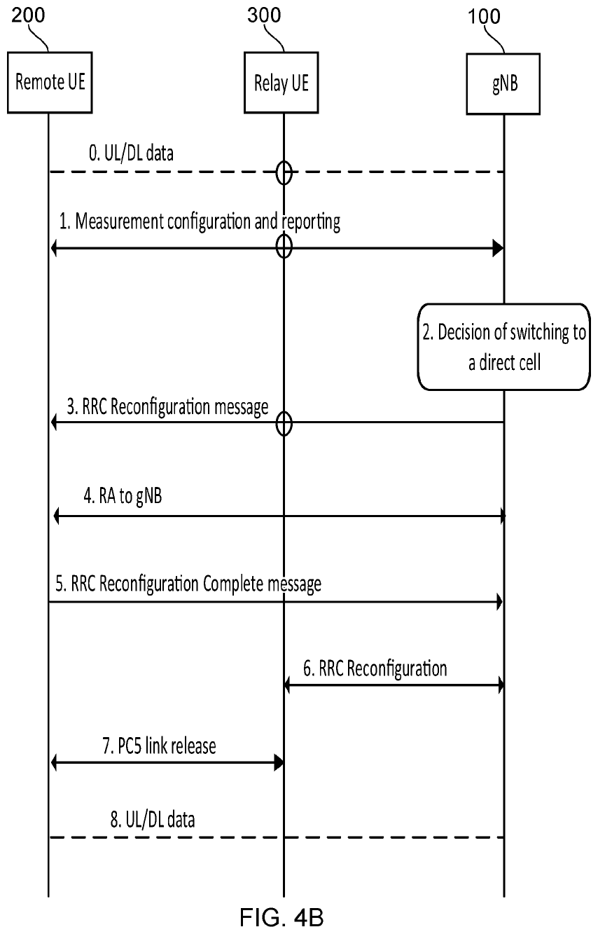

Release-17 of the 3GPP standards have been concerned with link switch procedures which involve switching the remote UE 200 from communicating via the direct path to communicating via the indirect path and vice versa. A link switch from the indirect path to the direct path involves handing over the remote UE 200 from the relay UE 300 to the gNB 100. An example of an indirect-to-direct path switch is shown in FIG. 4A. In FIG. 4A, before handover, the remote UE 200 is transmitting signals to and/or receiving signals from the gNB 100 via the relay UF 300. In particular, the remote UE 200 transmits signals to and/or receive signals via the wireless communications links 350, 450 forming the indirect path. After a decision has been made to handover the remote UE 200 to the gNB 100, the wireless communications links 350, 450 forming the indirect path are released (the release of a wireless communications link is represented as an “X” in FIG. 4A). Furthermore, the direct wireless communications link 250 is formed between the remote UE 200 and the gNB 100, thereby establishing the direct path between the remote UE 200 and the gNB 100 (the formation of a link is represented in FIG. 4A by dashed lines).

An example of a communications procedure for performing an indirect-to-direct handover, such as that shown in FIG. 4A, is illustrated in FIG. 4B (which has been reproduced from TS 38.300, v.17.0.0, the contents of which are hereby incorporated by reference).

In step 0, before handover, the remote UE 200 is transmitting uplink signals to and/or receiving downlink signals from the gNB 100 via the wireless communications links 350, 450 forming the indirect path. At this point, the direct wireless communications link 250 between the remote UE 200 and the gNB 100 has not been formed. Therefore, the direct wireless communications link 250 before handover may be referred to as a “candidate direct wireless communications link”.

In step 1, the gNB 100 transmits a measurement configuration to the remote UE 200 via the relay UE 300. The measurement configuration comprises a condition for triggering the remote UE 200 to transmit a measurement report to the gNB 100. The condition may alternatively be referred to as measurement reporting criteria. The measurement reporting criteria may be a condition on a measured quality of the sidelink wireless communications link 350 and/or a measured quality of the candidate direct wireless communications link 250 between the remote UF 200 and the gNB 100. For example, one condition in the measurement configuration may be that a measured quality of the sidelink wireless communications link 350 between the remote UE 200 and the relay UE 300 falls below a pre-defined threshold AND a measured quality of the candidate direct wireless communications link 250 between the remote UE 200 and the gNB 100 is above a pre-defined threshold. As will be appreciated by one skilled in the art, this condition may be referred to as “Event X1”. The pre-defined threshold may be the same or different in each case. Alternatively, a condition in the measurement configuration may that the measured quality of the sidelink wireless communications link 350 between the remote UE 200 and the relay UE 300 falls below a pre-defined threshold. As will be appreciated by one skilled in the art, this condition may be referred to as “Event X2”.

The measurements of the quality of the sidelink wireless communications link 350 may include measurements performed by the remote UE 200 on one or more reference signals received from the relay UE 300 over the sidelink wireless communications link 350. For example, the one or more measurements may one or more of a sidelink reference signal received power (SL-RSRP), a sidelink reference signal received quality (SL-RSRQ) and/or a signal to interference and noise ratio (SINR) of the one or more reference signals received from the relay UE 300. In some examples, the one or more reference signals may include a discovery reference signal.

As mentioned above, the candidate direct wireless communications link 250 has not yet been formed. However, as will be known to one skilled in the art, it is still possible for the remote UE 200 to receive one or more reference signals from the gNB 100. Therefore, the remote UE 200 measures the quality of the candidate direct wireless communications link 250 by performing one or more measurements on the reference signals received from the gNB 100 before the handover. The measurements of the quality of the candidate direct wireless communications link 250 may include measuring a reference signal received power (RSRP), a reference signal received quality (RSRQ) and/or a signal-to-noise ratio (SINR) of one or more reference signals received from the gNB 100.

The remote UE 200 then determines whether the measurement reporting criteria are met and, if so, the remote UE 200 transmits a measurement report to the gNB 100. The measurement report comprises an indication of the measurements of the sidelink wireless communications link 350. The measurement report may also include an indication of the measured quality of the candidate direct wireless communications link 250 between the remote UE 200 and the gNB 100, a layer 2 identification (L2 ID) of the remote UE 200, an L2 ID of the relay UE 300 and an ID of a serving cell of the gNB 100 (such as an NR Global Cell Identity (NCGI)).

In step 2, the gNB 100 determines to handover the remote UE 200 from the relay UE 300 to the gNB 100. In other words, the gNB 100 determines to switch the remote UE 200 from communicating on the indirect path to communicating on the direct path. This determination may be based on the measurement report received from the remote UE 200 in step 1.

In step 3, the gNB 100 sends an RRC Reconfiguration message to the remote UE 200 via the relay UE 300. In response to receiving the RRC Reconfiguration message, the remote UE 200 stops user plane (UP) and control plane (CP) transmission via the relay UE 300.

In step 4, the remote UE 200 forms the direct wireless communications link 250 with the gNB 100. For example, remote UE 200 may synchronise with the gNB 100 and perform Random Access (RA) to form an RRC connection. From this point forwards, communications between the remote UE 200 and the gNB 100 are via the direct path using the direct wireless communications link 250.

In step 5, the remote UE 200 sends an RRC Reconfiguration Complete to the gNB 100 via the direct path based on the configuration provided in the RRC Reconfiguration message.

In step 6, the gNB 100 sends an RRC Reconfiguration message to the relay UE 300 to reconfigure the connection between relay UE 300 and the gNB 100. The RRC Reconfiguration message to the relay UE 300 may be sent any time after step 3. The RRC reconfiguration message may indicate to the relay UE 300 to release the wireless communications links forming 350, 450 the indirect path. For example, the RRC reconfiguration message may indicate to release an RLC channel configuration and/or bearer configuration of the wireless communications links 350, 450 forming the indirect path.

In step 7, either the relay UE 300 or the remote UE 200 initiates the release of the sidelink wireless communications link 350. For example, the relay UE 300 may release the sidelink wireless communications link 350 in response to receiving the RRC reconfiguration message from the gNB 100 in step 6. Alternatively, the remote UE 200 may release the sidelink wireless communications link in response to receiving the RRC reconfiguration message from the g NB 100 in step 3. Releasing the sidelink wireless communications link 350 may comprise executing a PC5 connection reconfiguration procedure.

In step 8, the remote UE 200 transmits uplink signals to and/or receive downlink signals from the gNB 100 via the direct wireless communications link 250. In other words, the indirect-to-direct handover has been completed. Although not shown in FIG. 4B, a PDCP data recovery procedure may be executed during the handover to ensure lossless data delivery on the uplink and downlink.

As will be appreciated by one skilled in the art, step 8 can be executed any time after step 4, and step 8 is independent of step 6 and step 7.

The procedure illustrated in FIGS. 4A and 4B may alternatively be referred to as a U2N to direct cell handover.

### Direct-to-Indirect Handover

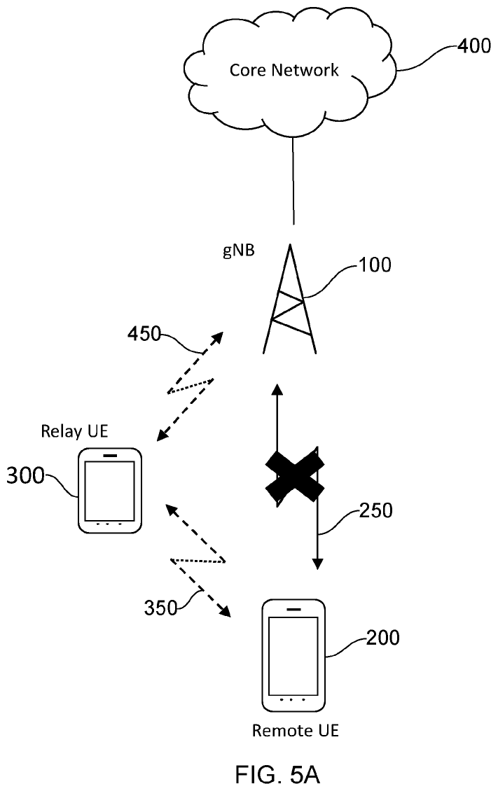

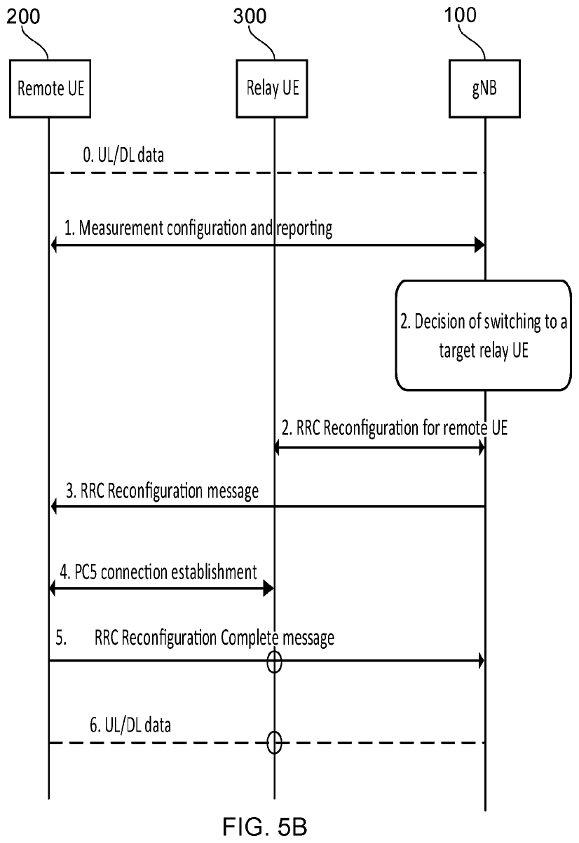

A link switch from the direct path to the indirect path involves handing over the remote UE 200 from the gNB 100 to the relay UE 300. An example of a direct-to-indirect path switch is shown in FIG. 5A. In FIG. 5A, the remote UE 200 is initially transmitting signals to and/or receiving signals from the gNB 100 via the wireless communications link 250 between the remote UE 200 and the gNB 100. After a decision has been made to handover the remote UE 200 to the relay UE 300, the direct wireless communications link 250 between the remote UE 200 and the gNB 100 is released. Then, the wireless communications links 350, 450 forming the indirect path between the remote UE 200 and the relay UE 300, and between the relay UE 300 and the gNB 100 respectively, are formed. In some embodiments, the direct wireless communications link 450 between the relay UE 300 and the gNB 100 may be already formed before the multipath handover.

An example of a communications procedure for performing an direct-to-indirect handover, such as that shown in FIG. 5A, is illustrated in FIG. 5B (which has been reproduced from TS 38.300, v.17.0.0, the contents of which are hereby incorporated by reference).

In step 0, before handover, the remote UE 200 is transmitting uplink signals to and/or receiving downlink signals from the gNB 100 via the direct wireless communications link 250. At this point, the sidelink wireless communications link 350 between the remote UF 200 and the relay UF 300 has not been formed. Therefore, the sidelink wireless communications link 350 before handover may be referred to as a “candidate sidelink wireless communications link”.

In step 1, the gNB 100 transmits a measurement configuration to the remote UE 200 via the direct wireless communications link 250. The measurement configuration comprises a condition for triggering the remote UE 200 to transmit a measurement report to the gNB 100. The condition may alternatively be referred to as measurement reporting criteria. The measurement reporting criteria may include a condition on a measured quality of the direct wireless communications link 250 between the remote UE 200 and the gNB 100 and/or a measured quality of the candidate sidelink wireless communications link 350 between the remote UE 200 and the relay UE 300. For example, one condition in the measurement configuration may be that a measured quality of the direct wireless communications link 250 between the remote UE 200 and the gNB 100 falls below a pre-defined threshold AND a measured quality of the candidate sidelink wireless communications link 350 between the remote UE 200 and the relay UE 300 is above a pre-defined threshold. As will be appreciated by one skilled in the art, this condition may be referred to as “Event Y1”. The pre-defined threshold may be the same or different in each case. Alternatively, a condition in the measurement configuration may be: the measured quality of the candidate sidelink wireless communications link 350 between the remote UE 200 and the relay UE 300 is above a pre-defined threshold. As will be appreciated by one skilled in the art, this condition may be referred to as “Event Y2”.

The measurements of the quality of the direct wireless communications link 250 may include measurements performed by the remote UE 200 on one or more reference signals received from the gNB 100 over the direct wireless communications link 250. For example, the one or more measurements may be one or more of a reference signal received power (RSRP), a reference signal received quality (RSRQ) and/or a signal-to-noise ratio (SINR) of one or more reference signals received from gNB 100.

As mentioned above, the candidate sidelink wireless communications link 350 has not yet been formed. However, as will be known to one skilled in the art, it is still possible for the remote UE 300 to receive one or more reference signals from the relay UE 300. Therefore, the remote UE 300 measures the quality of the candidate sidelink wireless communications link 350 by performing one or more measurements on the reference signals received from the relay UE 300 before the handover. The measurements of the quality of the candidate sidelink wireless communications link 350 may include sidelink reference signal received power (SL-RSRP), a sidelink reference signal received quality (SL-RSRQ) and/or a signal to interference and noise ratio (SINR) of the one or more reference signals received from the relay UE 300. In some examples, the one or more reference signals may include a discovery reference signal.

The remote UE 200 then determines whether the measurement reporting criteria are met and, if so, the remote UE 200 transmits a measurement report to the gNB 100. The measurement report comprises an indication of the measurements of the direct wireless communications link 250. The measurement report may also include an indication of the measured quality of the candidate sidelink wireless communications link 350 between the remote UE 200 and relay UE 300, a relay UE 300 ID, and an ID of the serving cell of the relay UE 300.

In step 2, the gNB 100 determines to handover the remote UE 200 from the gNB 100 to the relay UE 300. In other words, the gNB determines to switch the remote UE 200 from communicating on the direct path to communication on the indirect path. This determination may be based on the measurement report received in step 1. Then, the gNB 100 sends an RRC Reconfiguration message to the relay UE 300. The RRC reconfiguration message may include one or more of a local ID of the remote UE 100, an L2 ID of the remote UE 200, an RLC and/or bearer configuration for the candidate sidelink wireless communications link 350.

In step 3, the gNB 100 sends the RRC Reconfiguration message to the remote UE 200. The RRC Reconfiguration message may include one or more of an ID of the relay UE 300, an RLC and/or bearer configuration for the candidate sidelink wireless communications link 350. In response to receiving the RRC reconfiguration message, the remote UE 200 stops UP and CP transmission over the direct wireless communications link 250.

In step 4, the remote UE 200 forms the sidelink wireless communications link 350 with the relay UE 300. For example, the remote UE 200 establishes a PC5 connection with relay UE 300

In step 5, the remote UE 200 sends an RRC Reconfiguration Complete message to the gNB 100 via the relay UE 300.

In step 6, the remote UE 200 transmits signals to and/or receives signals from the gNB 100 via the relay UE 300 using the indirect path.

In cases where the relay UE 300 is in an RRC_IDLE or RRC_INACTIVE state, the remote UE 200 may, in response to receiving the RRC configuration message, establish the sidelink wireless communications link 350 with the relay UE 30 and send the RRC reconfiguration complete message via the relay UE 300. This will trigger the relay UE 300 to enter the RRC_CONNECTED state. In such cases, step 4 will be performed before step 2.

The procedure illustrated in FIGS. 5A and 5B may alternatively be referred to as a direct cell to U2N handover.

### Multipath

As discussed above, in conventional wireless communications networks, a UE can communicate with a gNB via a direct path or via an indirect path. However, Release-18 of the 3GPP standards are expected to support “Multipath UEs” which can simultaneously communicate via a direct path and an indirect path. For example, if the remote UE 300 is a multipath UE, then the remote UE 300 can communicate simultaneously with the gNB 100 via the direct path and via the indirect path. In other words, the remote UE 200 may transmit signals to and/or receive signals from the gNB 100 via the direct wireless communications link 250 between the remote UE 200 and the gNB 100 and, simultaneously, the remote UE 200 may transmit signals to and/or receive signals from the gNB 100 via the wireless communications links 350, 450 between the remote UE 200 and the relay UE 300, and between the relay UE 300 and the gNB 100.

Multipath UEs can provide enhancements to current wireless communications networks by improving both reliability and throughput. For example, the direct path and the indirect path may be used to transmit the same data and, therefore, if either of the direct or indirect path experiences radio link failure, the data can still be successfully transmitted via the other path, thereby increasing reliability. In other examples, the direct path and the indirect path may be used to transmit different data, thereby increasing throughput.

However, as will be explained in more detail below with reference to scenarios 1 to 5, the present application recognises that the introduction of UEs with multipath capabilities can create technical challenges for handovers involving a multipath UE with multiple active communications paths.

Scenarios 1 to 5 represent examples of handovers involving a multipath UE. In each of scenarios 1 to 5, before handover, the remote UE 200 is simultaneously connected to the gNB 100 via the direct path and the indirect path. Accordingly, from this point forward, the remote UE 200 should be assumed to have multipath capabilities, the relay UE 300 will be referred to as a “source relay UE 300” and the gNB 100 will be referred to as a “source gNB 100”.

Reference will be made below to a “target gNB”. This means that the gNB is a target of the handover. A target g NB may be a gNB with which the remote UE 200 forms a direct path after the handover, or a gNB with which the remote UE 200 forms an indirect path after the handover, or a gNB with which the remote UE forms both a direct path and an indirect path after the handover.

Reference will be made below to a “target relay UE”. This means that the UE is a target of the handover. A target relay UE may be a UE with which the remote UE forms a sidelink wireless communications link after the handover. A target relay UE may be under the control of either the source gNB or the target gNB.

Reference will be made below to a “source gNB”. This means that the gNB is a source of the handover. A source gNB may be a gNB with which the remote UE 200 forms a direct path before the handover, or a gNB with which the remote UE 200 forms an indirect path before the handover, or a gNB with which the remote UE forms both a direct path and an indirect path before the handover.

### Scenario 1

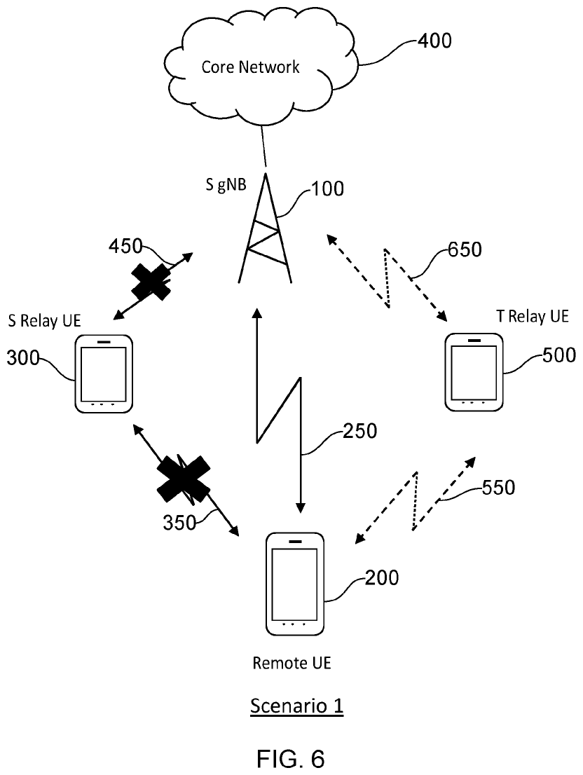

Scenario 1 is schematically illustrated in FIG. 6. As shown in FIG. 6, the remote UE 200 is handed over from the source relay UE 300 to a target relay UE 500 to form a new indirect path to the source gNB 100, while the direct path to the source gNB 100 is maintained. The new indirect path to the source gNB 100 comprises a sidelink wireless communications link 550 between the remote UE 200 and the target relay UE 500 and a direct wireless communications link 650 between the target relay UE 500 and the source gNB 100. Therefore, after handover, the remote UE 200 communicates with the source gNB 100 simultaneously via the direct path and via the new indirect path. In scenario 1, the source relay UF 300 and the target relay UE 500 are controlled by the same gNB. The direct wireless communications link 650 between the target relay UE 500 and the source gNB 100 may or may not be already formed before the multipath handover.

It is expected that such a handover procedure will be adequately supported by the communications procedure described with reference to FIG. 5A with minor modifications.

### Scenario 2

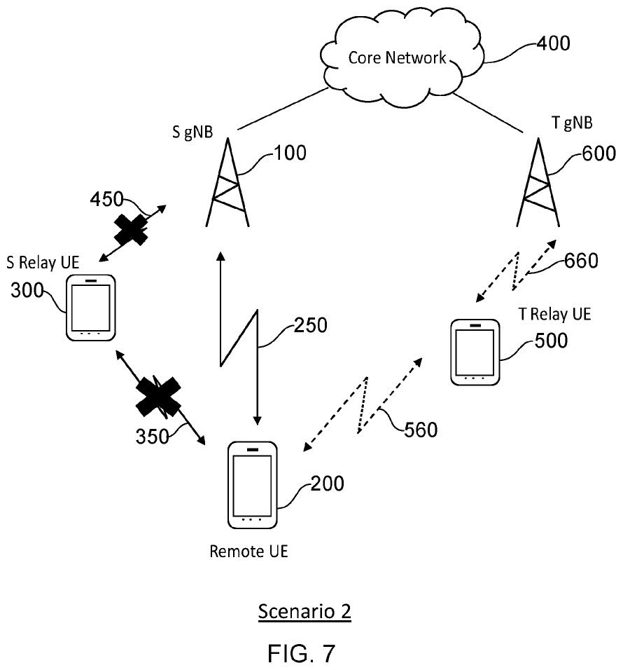

Scenario 2 is schematically illustrated in FIG. 7. As shown in FIG. 7, the remote UE 200 is handed over from the source relay UE 300 to a target relay UE 500 to form a new indirect path to a target gNB 600, while the direct path to the source gNB 100 is maintained. The new indirect path to the target gNB 600 comprises a sidelink wireless communications link 560 between the remote UE 200 and the target relay UE 500 and a direct wireless communications link 660 between the target relay UE 500 and the target gNB 600. Therefore, after handover, the remote UE 200 communicates simultaneously with the source gNB 100 via the direct path and with the target gNB 600 via the new indirect path. In scenario 2, the source relay UE 300 and the target relay UE 500 are controlled by different gNBs. The direct wireless communications link 660 between the target relay UE 500 and the target gNB 600 may or may not be already formed before the multipath handover.

It is expected that such a handover procedure will be adequately supported by the communications procedure described with reference to FIG. 5A with minor modifications. The communications procedure may involve a procedure for negotiation with the target gNB 600 which controls the target relay UE 500.

### Scenario 3

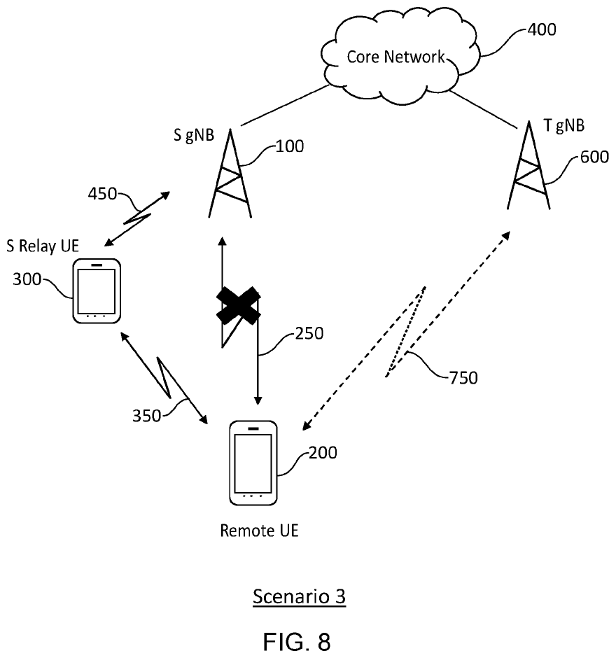

Scenario 3 is schematically illustrated in FIG. 8. As shown in FIG. 8, the remote UE 200 is handed over from the source gNB 100 to the target gNB 600 to form a new direct path to the target gNB 600. The new direct path comprises a direct wireless communications link 750 between the remote UE 200 and the target gNB 600. The indirect path to the source gNB 100 is maintained. Therefore, after handover, the remote UE 200 simultaneously communicates with the source gNB 100 via the indirect path and with the target gNB 600 via the new direct path.

It is expected that such a handover procedure will be adequately supported by legacy communications procedures for Uu link handovers.

### Scenario 4

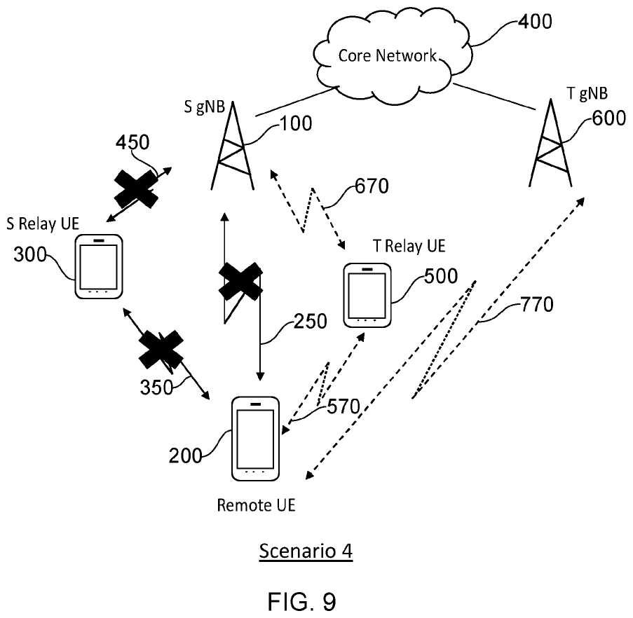

Scenario 4 is schematically illustrated in FIG. 9. As shown in FIG. 9, the remote UE 200 is handed over from the source gNB 100 and the source relay UE 300 to the target gNB 600 and the target relay UE 500. As such, the handover of scenario 4 may be referred to as a “multipath handover”. Specifically, the remote UE 200 is handed over to form a new direct path to the target gNB 600 and a new indirect path to the source gNB 100. The new direct path to the target gNB 600 comprises a direct wireless communications link 770 between the remote UE 200 and the target gNB 600. The new indirect path to the source gNB 100 comprises a sidelink wireless communications link 570 between the remote UE 200 and the target relay UE 500, and a direct wireless communications link 670 between the target relay UE 500 and the source gNB 100. In scenario 4, after handover, the remote UE 200 communicates simultaneously with the source gNB 100 via the new indirect path and with the target gNB 600 via the new direct path. The direct wireless communications link 670 between the target relay UE 500 and the source gNB 100 may or may not be already formed before the multipath handover.

### Scenario 5

In scenario 5, similarly to scenario 4, the remote UE 200 is handed over from the source gNB 100 and the source relay UE 300 to the target gNB 600 and the target relay UE 500. As such, the handover of scenario 5 may be referred to as a “multipath handover”. However, scenario 5 differs from scenario 4 in that the target relay UE 500 is controlled by a different gNB than the source gNB 100.

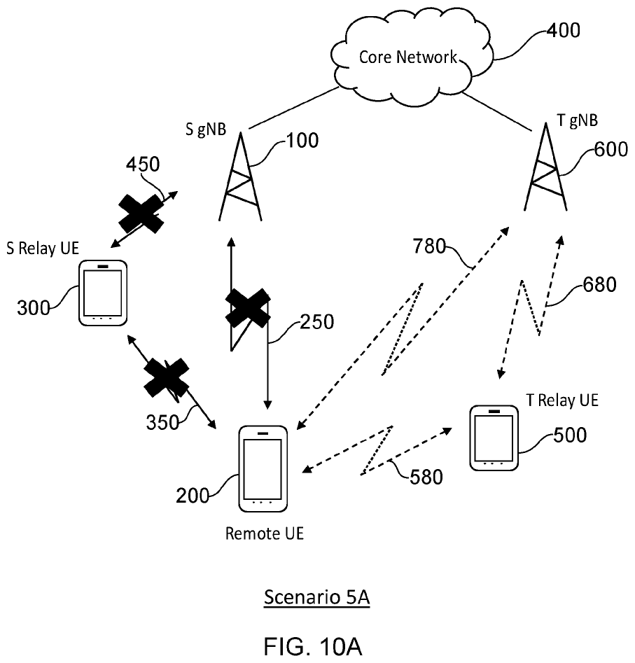

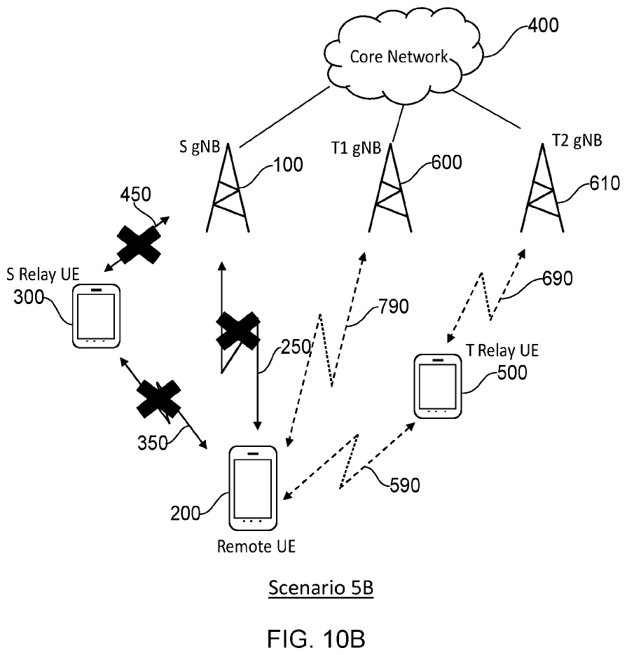

FIG. 10A represents a first example of scenario 5, namely, scenario 5A. In scenario 5A, the remote UE 200 is handed over to form a new direct path to the target gNB 600 and a new indirect path to the target gNB 600. The new direct path to the target gNB 600 comprises a direct wireless communications link 780 between the remote UE 200 and the target gNB 600. The new indirect path to the target gNB 600 comprises a sidelink wireless communications link 580 between the remote UE 200 and the target relay UE 500, and a direct wireless communications link 680 between the target relay UE 500 and the target gNB 600. In scenario 5A, the target gNB 600 controls the target relay UE 500. The target relay UE 500 may be located in a cell provided by the target gNB 600. In scenario 5A, after handover, the remote UE 200 communicates simultaneously with the target gNB 600 via the new indirect path and with the target gNB 600 via the new direct path. The direct wireless communications link 680 between the target relay UE 500 and the target gNB 600 may or may not be already formed before the multipath handover.

FIG. 10B represents a second example of scenario 5, namely, scenario 5B. In scenario 5B, the remote UE 200 is handed over from the source gNB 100 and the source relay UE 300 to form a new direct path to the target gNB 600 (which is an example of a “first target gNB 600”) and to form a new indirect path to a second target gNB 610. In scenario 5B, the second target gNB 610 controls the target relay UE 500. The target relay UE 500 may be located in a cell provided by the second target gNB 610. The new direct path to the first target gNB 600 comprises a direct wireless communications link 790 between the remote UE 200 and the first target gNB 600. The new indirect path to the second target g NB 610 comprises a sidelink wireless communications link 590 between the remote UE 200 and the target relay UE 500, and a direct wireless communications link 690 between the target relay UE 500 and the second target gNB 610. In scenario 5B, after handover, the remote UE 200 communicates simultaneously with the first target gNB 600 via the new direct path and with the second target gNB 610 via the new indirect path. The direct wireless communications link 690 between the target relay UE 500 and the second target gNB 610 may or may not be already formed before the multipath handover.

Therefore, scenarios 4 and 5 involve multipath handovers in which both a direct wireless communications link to a gNB (such as a Uu link) and a sidelink wireless communications link (such as a PC5 link) arc switched. New communications devices, infrastructure equipment and methods are required to support such multipath handover procedures.

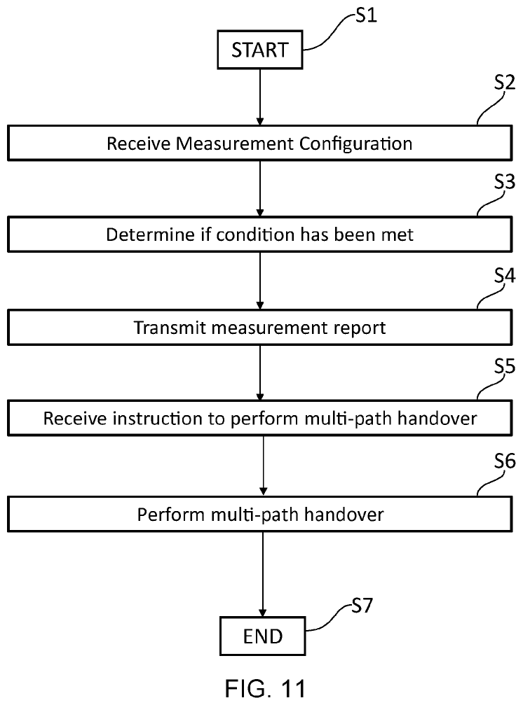

In view of the above, there is provided a method of operating a communications device to perform a multi-path handover from a source infrastructure equipment of a wireless communications network and a source relay communications device to a target infrastructure equipment of the wireless communications network and a target relay communications device. Such a method will now be described with reference to FIG. 11. The method starts at step 1.

In step S2, the communications device receives, from the source infrastructure equipment, a measurement configuration comprising a condition for triggering the communications device to transmit a measurement report to the source infrastructure equipment. The condition is based on a quality of a wireless communications link between the communications device and the source infrastructure equipment and a quality of a wireless communications link between the communications device and the source relay communications device. In some embodiments, the condition is a condition that the measured quality of the wireless communications link between the communications device and the source infrastructure equipment is below a first predefined threshold and that the measured quality of the wireless communications link between the communications device and the source relay communications device is below a second pre-defined threshold. The first and second threshold may be the same or different. The thresholds may be based on one or more of an RSRP, RSRQ, and SINR of one or more reference signals received over the wireless communications links between the communications device and the source infrastructure equipment, and between the communications device and the source relay communications device.

In step S3, the communications device determines, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met. For example, the communications device may determine that the measured quality of the wireless communications link between the communications device and the source infrastructure equipment is below the first predefined threshold and that the measured quality of the wireless communications link between the communications device and the relay communications device is below the second predefined threshold. In some embodiments, the communications device performs the measurements of the quality of the wireless communications links with the source infrastructure equipment and source relay communications device. In some embodiments, the source relay communications device performs the measurements of the quality of the wireless communications link between the communications device and the source relay communications device. In some embodiments, the source infrastructure equipment performs the measurements of the quality of the wireless communications link between the communications device and the source infrastructure equipment. Measurements of a quality of a wireless communications link may alternatively be referred to as measurements of a quality of a cell. For example, measurements of the quality of the wireless communications link between the communications device and the source infrastructure equipment may be referred to as measurements of the quality of a cell provided by the source infrastructure equipment. Similarly, measurements of the quality of the wireless communications link between the communications device and the source relay communications device may be referred to as measurements of the quality of a cell provided by the source relay communications device.

In step S4, the communications device transmits the measurement report to the source infrastructure equipment. The measurement report comprises an indication of the one or more measurements of the wireless communications link between the communications device and the source infrastructure equipment and the one or more measurements of the wireless communications link between the communications device and the source relay communications device. For example, the indication may be an indication that the condition was met. In some embodiments, the indication may include the measurements of the quality of the wireless communications link between the communications device and the source infrastructure equipment. In some embodiments, the indication may include the measurements of the quality of the wireless communications link between the communications device and the source relay communications device.

In some embodiments, the communications device measures a quality of a wireless communications link to be formed between communications device and the target infrastructure equipment. For example, before the wireless communications link is formed, the communications device may receive one or more reference signals from the target infrastructure equipment and perform one or more measurements on the reference signals. The one or more measurements on the reference signals may include measuring a RSRP, RSRQ, and/or SINR of the reference signals. The one or more measurements may be included in the measurement report.

In some embodiments, the communications device measures a quality of a wireless communications link to be formed between communications device and the target relay communications device. For example, before the wireless communications link is formed, the communications device may receive one or more reference signals from the target relay communications device and perform one or more measurements on the reference signals. The one or more measurements on the reference signals may include measuring a SL-RSRP, SL-RSRQ, and/or SINR of the reference signals. The one or more measurements may be included in the measurement report.

The communications device may associate a unique measurement ID with the measurements of each wireless communications link. For example, the measurement ID for the measurements of the wireless communications link between the communications device and the source infrastructure equipment may be different to the measurement ID for the measurements of the wireless communications link between the communications device and the source relay communications device which is different to the measurement ID for the measurements of the wireless communications link to be formed between the communications device and the target infrastructure equipment which is different to the measurement ID for the measurements of the wireless communications link to be formed between the communications device and the target relay communications device. The measurement ID associated with the measurements of each wireless communications link may be included in the measurement report.

In step S5, the communications device receives, from the source infrastructure equipment, an instruction to perform the multi-path handover from the source infrastructure equipment and source relay communications device to the target infrastructure equipment and target relay communications device. The instruction may be explicit or implicit. For example, the communications device may receive a configuration for a wireless communications link to be formed with the target infrastructure equipment and a configuration for a wireless communications link to be formed with the target relay communications device. The communications device may implicitly determine from the received configurations that the source infrastructure equipment is instructing the communications device to perform the multipath handover. The configurations may be transmitted in the same message such as an RRC reconfiguration message.

In step S6, the communications device performs the multi-path handover in accordance with the instruction received from the source infrastructure equipment. For example, the communications device may form a wireless communications link with the target infrastructure equipment and form a wireless communications link with the target relay communications device. The communications device may release the wireless communications link with the source infrastructure equipment and with the source relay communications device.

The method ends in step S7.

In the method discussed with reference to FIG. 11 above, the source and target infrastructure equipment of the wireless communications network may each be a gNB and the communications device, source relay communications device and target relay communications device may each be a UE. The wireless communications link between the communications device and the source or target infrastructure equipment may be referred to as a direct wireless communications link such as a Uu interface. The wireless communications link between the communications device and the source or target relay communications device may be referred to as a sidelink wireless communications link such as a PC5 interface. The source infrastructure equipment may or may not control the source relay communications device. Similarly, the target infrastructure equipment may or may not control the target relay communications device. References to a communications device being under the “control” of an infrastructure equipment may mean that the communications device is connected to the infrastructure equipment, for example, by a direct or indirect path.

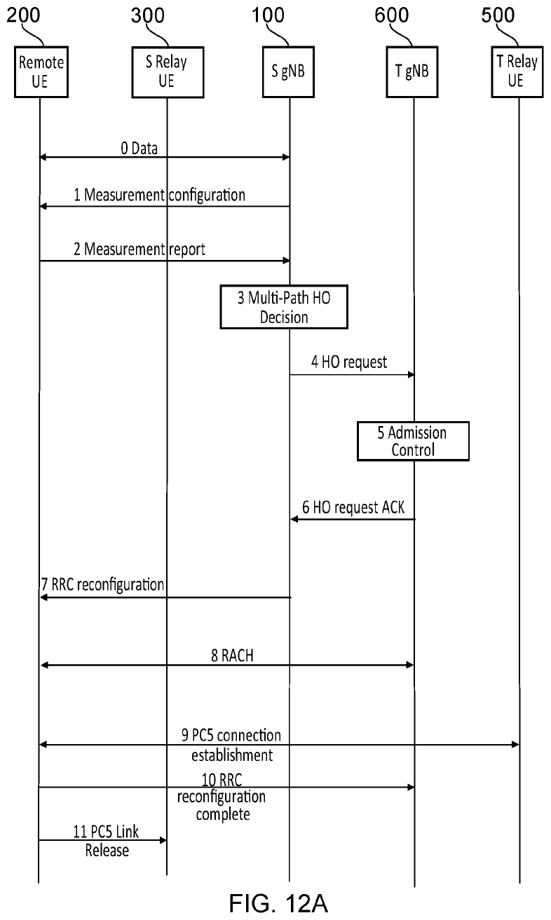

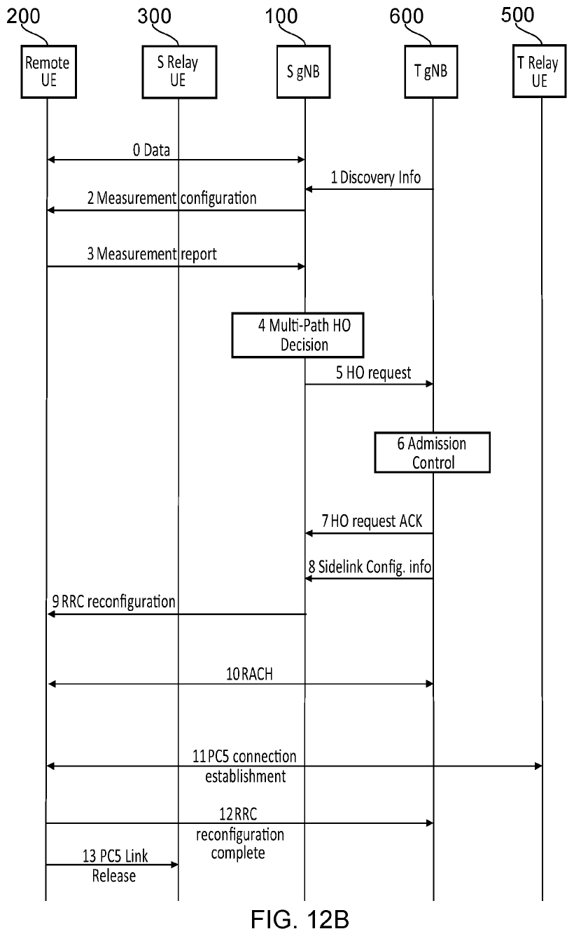

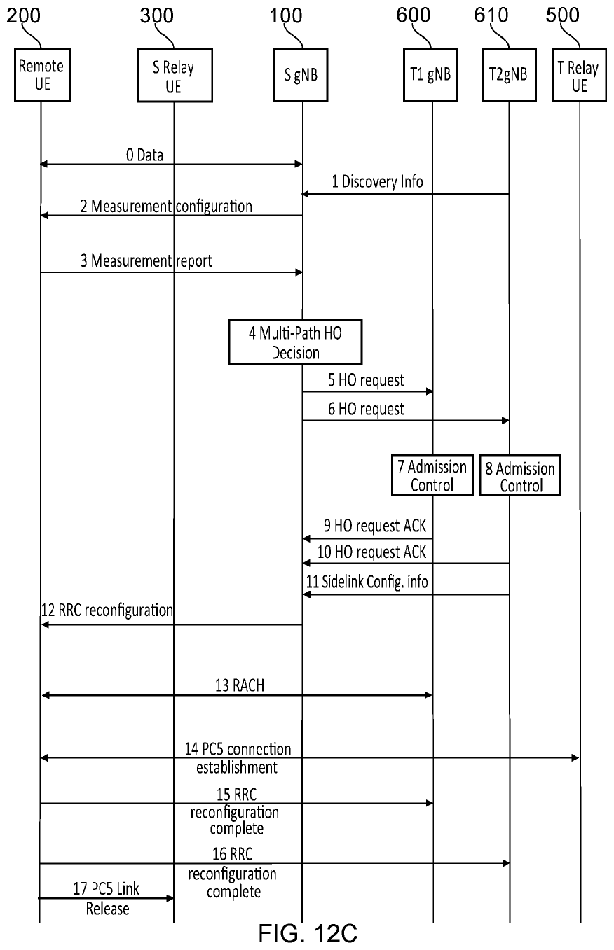

FIG. 12A illustrates an example of a communications procedure for a multipath handover such as that described with reference to scenario 4.

In step 0, before handover, the remote UE 200 transmits signals to and/or receives signals from the source gNB 100 via the direct path and/or the indirect path.

In step 1, the source gNB 100 transmits a measurement configuration to the remote UE 200. The measurement configuration may be transmitted to the remote UE 200 via the direct path or the indirect path. The measurement configuration comprises a condition for triggering the remote UE 200 to transmit a measurement report to the source gNB 100. The condition may alternatively be referred to as measurement reporting criteria.

In some embodiments, the condition is a condition that the measured quality of the direct wireless communications link 250 between the remote UE 200 and the source g NB 100 is below a pre-defined threshold AND the measured quality of the sidelink wireless communications link 250 between the remote UE 200 and the source relay UE 300 is below the same pre-defined threshold. For example, the condition may be that one or more of an RSRP, RSRQ and/or SINR of one or more reference signals received from the gNB 100 fall below the predefined threshold AND that one or more of an SL-RSRP, SL-RSRQ and/or SINR of one or more reference signals received from the source relay UF 300 fall below the predefined threshold.

In some embodiments, the condition is a condition that the measured quality of the direct wireless communications link 250 between the remote UE 200 and the source gNB 100 is below a first predefined threshold AND the measured quality of the sidelink wireless communications link 250 between the remote UE 200 and the source relay UE 300 is below a second, different predefined threshold. For example, the condition may be that one or more of an RSRP, RSRQ and/or SINR of one or more reference signals received from the gNB 100 fall below a first predefined threshold AND that one or more of an SL-RSRP, SL-RSRQ and/or SINR of one or more reference signals received from the source relay UE 300 fall below a second, different predefined threshold.

After receiving the measurement configuration, the remote UE 200 may monitor the quality of the direct wireless communications link 250 and the sidelink wireless communications link. For example, the remote UE 200 may measure the quality of the direct wireless communications link 250 and the sidelink wireless communications link. The measurements may be performed periodically or continuously, for example.

The measurements of the quality of the direct wireless communications link 250 may comprise one or more measurements of one or more reference signals received from the source gNB 100 over the direct wireless communications link 250. For example, the one or more measurements may be one or more of an RSRP, RSRQ and/or SINR of the one or more reference signals received from the source gNB 100. In some examples, the one or more reference signals may include a discovery reference signal.

The measurements of the quality of the sidelink wireless communications link 350 may comprise one or more measurements of one or more reference signals received from the source relay UE 300 over the sidelink wireless communications link 350. The measurements of the quality of the sidelink wireless communications link 350 may comprise one or more measurements of one or more reference signals received from the source relay UE 300 over the sidelink wireless communications link 350. For example, the one or more measurements may be one or more of an SL-RSRP, SL-RSRQ and/or SINR of the one or more reference signals received from the source relay UE 300.

In some embodiments, the remote UE 200 monitors the quality of the sidelink wireless communications link 570 to be formed between the remote UE 200 and the target relay UE 500. For example, the remote UE 200 may receive one or more reference signals from the target relay UE 500 and perform one or more measurements on the reference signals. The one or more measurements on the reference signals may include measuring an SL-RSRP, SL-RSRQ, and/or SINR of the reference signals. The one or more measurements may be included in the measurement report.

In some embodiments, the remote UE 200 monitors the direct wireless communications link 770 to be formed between the remote UE 200 and the target gNB 600. For example, the remote UE 200 may receive one or more reference signals from the target gNB 600 and perform one or more measurements on the reference signals. The one or more measurements on the reference signals may include measuring a RSRP, RSRQ, and/or SINR of the reference signals. The one or more measurements may be included in the measurement report.

The remote UE 200 may associate a unique measurement ID with the measurements of each of the wireless communications links 250, 350, 570, 770. For example, the measurement ID for the measurements of each of the wireless communications links 250, 350, 570, 700 may be different. The measurement ID associated with the measurements of each of the wireless communications links 250, 350, 570, 700 may be included in the measurement report.

In step 2, the remote UE 200 determines that the condition in the measurement configuration have been met and, in response, transmits a measurement report to the source gNB 100 via either the direct path or the indirect path. The measurement report includes an indication of the measurements of the quality of the direct wireless communications link 250 and the sidelink wireless communications link 350. For example, the indication may be an indication that the condition was met. In some embodiments, the indication may include the measurements of the quality of the wireless communications link 250 and the sidelink wireless communications link 350.

In step 3, the source gNB 100 determines, based on the measurement report received from the remote UE 200, to perform the multipath handover.

In step 4, the source gNB 100 transmits a multipath handover request to the target gNB 600.

In step 5, the target gNB 600 performs admission control.

In step 6, the target gNB 600 transmits a multipath handover request acknowledgement to the source gNB 100.

In step 7, the source gNB 100 determines a configuration for both the direct wireless communications link 770 to be formed between the remote UE 200 and the target gNB 600 and a configuration for the sidelink wireless communications link 570 to be formed between the remote UE 200 and the target relay UE 500. The source gNB 100 then transmits the configurations to the remote UE 200 either via the direct path or the indirect path. In some embodiments, the configurations are transmitted in the same message. In some embodiments, the configurations are transmitted in an RRC reconfiguration message. In such embodiments, the RRC reconfiguration message includes an RRC configuration for the direct wireless communications link 770 to be formed between the remote UE 200 and the target gNB 600 and for the sidelink wireless communications link 570 to be formed between the remote UE 200 and the target relay UE 500.

In step 8, the remote UE 200 forms the direct wireless communications link 770 with the target gNB 600. For example, the remote UE 200 may perform a random access channel (RACH) procedure with the target gNB 600 to form the direct wireless communications link 770 between the remote UE 200 and the target gNB 600.

In step 9, the remote UE 200 forms the sidelink wireless communications link 570 with the target relay UE 500. For example, the remote UE 200 may perform a PC5 connection establishment procedure with the target relay UE 500 to form the sidelink wireless communications link 570 between the remote UE 200 and the target relay UE 500. In some embodiments, step 9 may be performed before, or simultaneously with, step 8.

In step 10, after forming the direct wireless communications link 770 with the target gNB 600 and forming the sidelink wireless communications link 570 with the target relay UE 500, the remote UE 200 transmits an RRC Reconfiguration complete message to the target gNB 600.

In step 11, the remote UE 200 transmits a link release message to the source relay UE 300. The link release message may comprise an instruction to release the sidelink wireless communications link 350 between the remote UE 200 and the source relay UF 300. In some embodiments, the link release message is a PC5 link release message.

FIG. 12B illustrates an example of a communications procedure for a multipath handover such as that described with reference to scenario 5A. The communications procedure in FIG. 12B is broadly similar to that described with reference to FIG. 12A. Therefore, in the interests of brevity, only the differences between FIG. 12B and FIG. 12A will be described.

Step 0 of FIG. 12B corresponds to step 0 of FIG. 12A.

In step 1, the source gNB 100 may receive discovery information from the target gNB 600 to enable the source gNB 100 to be aware of the target relay UE 500. The discovery information may be transmitted over an X2 interface between the source gNB 100 and target gNB 600, for example. The discovery information may include one or more of: discovery and/or measurement configurations for the target relay UE 500, an ID of the target relay UE 500, a sidelink reference signal and/or a sidelink reference signal configuration. In some embodiments, the discovery information also includes an ID of the target gNB 600 which controls the target relay gNB 500. In some embodiments, information in the discovery information which is related to the target relay UE 500 (such as the ID of the target relay UE 500 and/or the sidelink reference signal configuration) is included in the measurement configuration for the remote UE 200 to perform measurements. In some embodiments, the source gNB 100 transmits a request for the discovery information to the target gNB 600.

Steps 2 and 3 of FIG. 12B correspond to steps 1 and 2 respectively of FIG. 12A.

In step 4, the source gNB 100 determines, based on the measurement report received from the remote UE 200 and the discovery information received from the target gNB 600, to perform the multipath handover.

Steps 5 to 7 of FIG. 12B correspond to steps 4 to 6 respectively of FIG. 12A.

In step 8, the source gNB 100 receives sidelink configuration information from the target gNB 600. The sidelink configuration information may be transmitted over an X2 interface, for example. The sidelink configuration information may include information regarding the target relay UE 500 which can be used by the source gNB 100 to determine a configuration for the sidelink wireless communications link 580 to be formed between the remote UE 200 and the target relay UE 500. The sidelink configuration information may include one or more of a PC5 RLC channel configuration of the sidelink wireless communications link 580 to be formed between the remote UE 200 and the target relay UE 500 and a bearer mapping configuration between the PC5 RLC and a Uu RLC of the direct wireless communications link 680 between the target relay UE 500 and the target gNB 600.

In step 9, the source gNB 100 determines a configuration for both the direct wireless communications link 780 to be formed between the remote UE 200 and the target gNB 600 and a configuration for the sidelink wireless communications link 580 to be formed between the remote UE 200 and the target relay UE 500. The determination of the configuration for the sidelink wireless communications link 580 to be formed between the remote UE 200 and the relay UE 500 is based on the sidelink configuration information received from the target gNB 600. The source gNB 100 then transmits the configurations to the remote UE 200 either via the direct path or the indirect path. In some embodiments, the configurations are transmitted in the same message. In some embodiments, the configurations are transmitted in an RRC reconfiguration message. In such embodiments, the RRC reconfiguration message includes an RRC configuration for the direct wireless communications link 780 to be formed between the remote UE 200 and the target gNB 600 and for the sidelink wireless communications link 580 to be formed between the remote UE 200 and the target relay UE 500.

In step 10, the remote UE 200 forms the direct wireless communications link 780 with the target gNB 600. For example, the remote UE 200 may perform a RACH procedure with the target gNB 600 to form the direct wireless communications link 780 between the remote UE 200 and the target gNB 600.

In step 11, the remote UE 200 forms the sidelink wireless communications link 580 with the target relay UE 500. For example, the remote UE 200 may perform a PC5 connection establishment procedure with the target relay UE 500 to form the sidelink wireless communications link 580 between the remote UE 200 and the target relay UE 500. In some embodiments, step 9 may be performed before, or simultaneously with, step 8.

In step 12, after forming the direct wireless communications link 780 with the target gNB 600 and forming the sidelink wireless communications link 580 with the target relay UE 500, the remote UE 200 transmits an RRC Reconfiguration complete message to the target gNB 600.

Step 13 of FIG. 12B corresponds to step 11 of FIG. 12A.

FIG. 12C illustrates an example of a communications procedure for a multipath handover such as that described with reference to scenario 5B. The communications procedure in FIG. 12C is broadly similar to that described with reference to FIGS. 12A and 12B. Therefore, in the interests of brevity, only the differences between FIG. 12C and FIGS. 12A and 12B will be described.

Step 0 of FIG. 12C corresponds to step 0 of FIG. 12A.

In step 1, the source gNB 100 may receive discovery information from the second target gNB 610 to enable the source gNB 100 to be made aware of the target relay UE 500. The discovery information may be transmitted over an X2 interface between the source gNB 100 and second target gNB 610, for example. The discovery information may include one or more of: discovery and/or measurement configurations for the target relay UE 500, an ID of the target relay UE 500, a sidelink reference signal and/or a sidelink reference signal configuration. In some embodiments, the discovery information also includes an ID of the second target gNB 610 which controls the target relay gNB 500. In some embodiments, information in the discovery information which is related to the target relay UE 500 (such as the ID of the target relay UE 500 and/or the sidelink reference signal configuration) is included in the measurement configuration for the remote UE 200 to perform measurements. In some embodiments, the source gNB 100 transmits a request for the discovery information to the second target gNB 610.

Steps 2 and 3 of FIG. 12B correspond to steps 1 and 2 respectively of FIG. 12A.

In step 4, the source gNB 100 determines, based on the measurement report received from the remote UE 200 and the discovery information received from the second target gNB 610, to perform the multipath handover.

In step 5, the source gNB 100 transmits a multipath handover request to the first target gNB 600. The transmission of the multipath handover request may be over an X2 interface for example. In step 6, the transmits a multipath handover request to the second target gNB 610. The transmission of the multipath handover request may be over an X2 interface for example.

In step 7, the first target gNB 600 performs admission control. In step 8, the second target gNB 610 performs admission control.

In step 9, the first target g NB 600 transmits a multipath handover request acknowledgement to the source gNB 100. In step 10, the second target gNB 610 transmits a multipath handover request acknowledgement to the source gNB 100.

In step 11, the source gNB 100 receives sidelink configuration information from the second target gNB 610. The sidelink configuration information may be transmitted over an X2 interface, for example. The sidelink configuration information may include information regarding the target relay UE 500 which can be used by the source gNB 100 to determine a configuration for the sidelink wireless communications link 590 to be formed between the remote UE 200 and the target relay UE 500. The sidelink configuration information may include one or more of a PC5 RLC channel configuration of the sidelink wireless communications link 590 to be formed between the remote UE 200 and the target relay UE 500 and a bearer mapping configuration between the PC5 RLC and a Uu RLC of the direct wireless communications link 690 between the target relay UE 500 and the second target gNB 600.

In step 12, the source gNB 100 determines a configuration for both the direct wireless communications link 790 to be formed between the remote UE 200 and the first target gNB 600 and a configuration for the sidelink wireless communications link 590 to be formed between the remote UE 200 and the target relay UE 500. The determination of the configuration for the sidelink wireless communications link 590 to be formed between the remote UE and the relay UE 500 is based on the sidelink configuration information received from the second target gNB 610. The source gNB 100 then transmits the configurations to the remote UE 200 either via the direct path or the indirect path. In some embodiments, the configurations are transmitted in the same message. In some embodiments, the configurations are transmitted in an RRC reconfiguration message. In such embodiments, the RRC reconfiguration message includes an RRC configuration for the direct wireless communications link 790 to be formed between the remote UE 200 and the first target gNB 600 and for the sidelink wireless communications link 590 to be formed between the remote UE 200 and the target relay UE 500.

In step 13, the remote UE 200 forms the direct wireless communications link 790 with the first target gNB 600. For example, the remote UE 200 may perform a RACH procedure with the first target gNB 600 to form the direct wireless communications link 790 between the remote UE 200 and the first target gNB 600.

In step 14, the remote UE 200 forms the sidelink wireless communications link 590 with the target relay UE 500. For example, the remote UE 200 may perform a PC5 connection establishment procedure with the target relay UE 500 to form the sidelink wireless communications link 590 between the remote UE 200 and the target relay UE 500. In some embodiments, step 14 may be performed before, or simultaneously with, step 13.

In step 15, after forming the direct wireless communications link 790 with the target gNB 600 and forming the sidelink wireless communications link 590 with the target relay UE 500, the remote UE 200 transmits an RRC Reconfiguration complete message to the first target gNB 600.

In step 16, the remote UE 200 transmits an RRC Reconfiguration complete message to the second target gNB 610.

Step 17 corresponds to step 11 of FIG. 12A.

### Multipath Connection Set-Up

As discussed above, embodiments can provide support for multipath handover procedures from a source gNB and a source relay UE to a target gNB and a target relay UE. However, scenarios 1 to 5 assume that, before handover, a remote UE is connected to a gNB via a direct path and is connected to the same gNB via a relay UE. As will be explained in more detail below, embodiments can also provide a UE which, before handover, is simultaneously connected to a gNB via a direct path and to a different gNB via an indirect path.

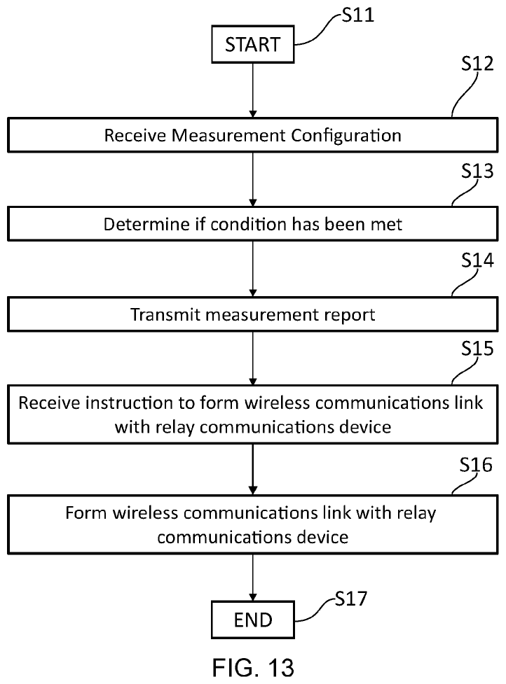

In view of the above, there is provided a method of operating a communications device to form a multipath connection to a first infrastructure equipment of a wireless communications network and a relay communications device controlled by a second infrastructure equipment of the wireless communications network. Such a method is illustrated in FIG. 13.

In step S11, the method starts.

In step S12, the communications device receives, from the first infrastructure equipment over a wireless communications link between the communications device and the first infrastructure equipment, a measurement configuration comprising a condition for triggering the communications device to transmit a measurement report to the first infrastructure equipment. The condition is based on a quality of a wireless communications link to be formed between the communications device and the relay communications device.

In step S13, the communications device determines, based on one or more measurements of a quality of the wireless communications link to be formed between the communications device and the relay communications device, that the condition for triggering the communications device to transmit the measurement report has been met. In some embodiments, the condition is a condition that the one or more measurements of the quality of the wireless communications link to be formed between the communications device and the relay communications device is above a predefined threshold. The threshold may be based on one or more of an RSRP, RSRQ, and SINR of one or more reference signals received from the relay communications device.

In step S14, the communications device transmits the measurement report to the first infrastructure equipment. The measurement report comprises an indication of the one or more measurements of the quality of the wireless communications link to be formed between the communications device and the relay communications device.

In step S15, the communications device receives, from the first infrastructure equipment, an instruction to form the wireless communications link with the relay communications device.

In step S16, the communications device forms the wireless communications link with the relay communications device.

In step S17, the method ends.

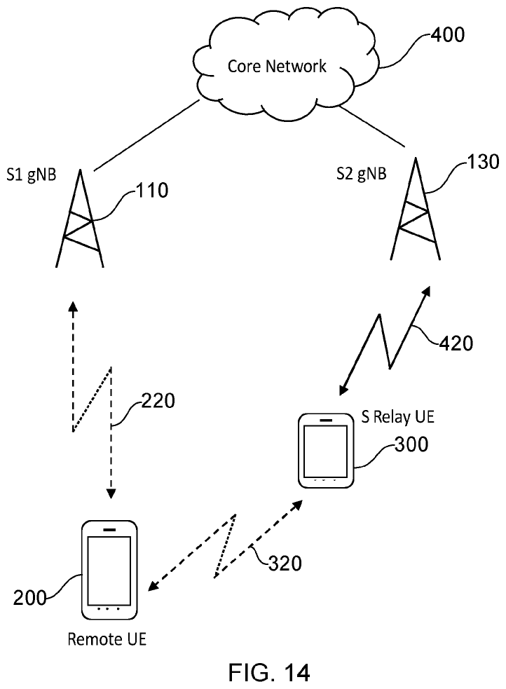

FIG. 14 schematically represents an example of a multipath connection set-up in accordance with example embodiments. As shown in FIG. 14, the remote UE 200 is forming a direct wireless communications link 220 (for example, Uu interface) with a first source gNB 110 and a sidelink wireless communications link 320 (for example, a PC5 interface) with the source relay UE 300. As shown in FIG. 14, the source relay UE 300 already has a direct wireless communications link 420 with the second source gNB 130 which may be formed by conventional Uu connection establishment procedures. The second source gNB 130 controls the source relay UE 300 which may be located in a cell provided by the second source gNB 130.

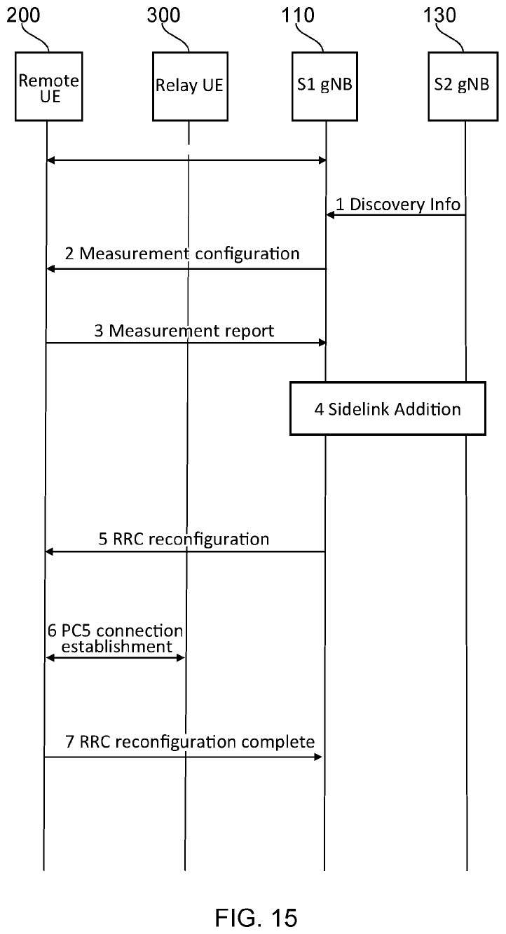

FIG. 15 illustrates a communications procedure for a multipath connection set-up such as that shown in FIG. 14.

In step 0, the remote UE 200 forms the direct wireless communications link 220 with the first source gNB 100. For example, the remote UE 200 may perform a Uu link connection set-up process with the first source gNB 110. Since the sidelink wireless communications link 320 has not yet been formed, it will be referred to as the “candidate sidelink wireless communications link”.

In step 1, the first source gNB 110 receives discovery information from the second source gNB 130 to enable the first source gNB 110 to be aware of the source relay UE 300. The discovery information be transmitted over an X2 interface between the first source gNB 110 and second source gNB 130, for example. The discovery information may include discovery and/or measurement configurations for the source relay UE 300. For example, the discovery information may include discovery configurations, an ID of the source relay UE 300 and/or a sidelink reference signal. In some embodiments, the discovery information received from also includes an ID of the second source gNB 130 which controls the source relay UE 300. In some embodiments, the discovery information is included in the measurement configuration transmitted in step 2 below. In some embodiments, the first source gNB 110 transmits a request for the discovery information to the second source gNB 130.

In step 2, the first source gNB 110 may transmit a measurement configuration to the remote UE 200 over the direct wireless communications link 220. The measurement configuration comprises a condition for triggering the remote UE 200 to transmit a measurement report to the first source gNB 110. The condition may alternatively be referred to as measurement reporting criteria.

The measurement reporting criteria may include a condition on a measured quality of the candidate sidelink wireless communications link 320. For example, one condition in the measurement configuration may be that a measured quality of the candidate sidelink wireless communications link 320 between the remote UE 200 and the source relay UE 300 is above a pre-defined threshold. As will be appreciated by on skilled in the art, this condition is known as “Event Y2”.

As mentioned above, the candidate sidelink wireless communications link 320 has not yet been formed. However, as will be known to one skilled in the art, it is still possible for the remote UE 200 to receive one or more reference signals from the source relay UE 300. Therefore, the remote UE 200 measures the quality of the candidate sidelink wireless communications link 320 by performing one or more measurements on the reference signals received from the source relay UE 300 before the sidelink wireless communications link 320 is formed. The measurements of the quality of the candidate sidelink wireless communications link 320 may include measuring an SL-RSRP, an SL-RSRP and/or an SINR of one or more reference signals received from the source relay UE 300.

In step 3, the remote UE 200 determines whether the conditions in the measurement configuration are met and, if so, the remote UE 200 transmits a measurement report to the first source gNB 100. The measurement report comprises an indication of the measured quality of the sidelink wireless communications link 320. The first source gNB 110 may determine, based on the measurement report, that the multipath connection setup should be performed. In some embodiments, the first source gNB 110 may determine that the multipath connection setup should be performed based on the measurement report and the discovery information.

In step 4, a sidelink addition procedure is performed between the first source gNB 110 and the second source gNB 130. During the sidelink addition procedure, the first source gNB 110 may transmit information on the remote UE 200 to the second source gNB 130. The information on the remote UE 200 may include one or more of an ID of the remote UE 200, context information of the remote UE 200 and QoS information of the remote UE 200. Furthermore, in step 4, the second source gNB 130 may transmit information on the source relay UE 300 to the first source gNB 110. The information on the source relay UE 300 may include one or more of an ID of the source relay UE 300, context information of the source relay UE 300, QoS information of the source relay UE 300 and a configuration for the candidate sidelink wireless communications link 320 to be formed with the source relay UE 300. For example, the configuration may be a PC5 channel configuration. In some embodiments, the information on the source relay UE 300 may include one or more of a PC5 RLC channel configuration of the candidate sidelink wireless communications link 320 to be formed between the remote UE 200 and the source relay UE 300 and a bearer mapping configuration between the PC5 RLC and a Uu RLC of the direct wireless communications link 420 between the source relay UE 300 and the second source gNB 130. Information exchanged between the first source gNB 110 and the second source gNB 130 as part of the sidelink addition procedure may be exchanged over an X2 interface. In some embodiments, the first source gNB 110 transmits a request to the second source gNB 130 for the information on the source relay UE 300.

In step 5, the first source gNB 110 transmits the configuration for the candidate sidelink wireless communications link 320 to the remote UE 200. The configuration may be transmitted in an RRC reconfiguration message.

In step 6, the remote UE 200 forms the sidelink wireless communications link 320 with the source relay UF 300 based on the configuration received from the first source gNB 110. For example, the remote UF 200 may perform a PC5 connection establishment procedure with the first source gNB 110.

In step 7, the remote UE 200 transmits an indication to the first source gNB 110 indicating that the sidelink wireless communications link 320 has been formed. For example, the remote UE 200 may transmit an RRC reconfiguration complete message to the first source gNB 110.

Therefore example embodiments can provide a multipath connection setup where a communications device is connected to a first infrastructure equipment and to a relay communications device which is controlled by a second infrastructure equipment. Therefore, to perform a multipath handover for such a communications device, the steps of FIG. 15 may precede the steps of FIG. 12A, 12B or 12C. In such a multipath handover, during the PC5 link release step (step 11 in FIG. 12A, step 13 in FIG. 12B and step 17 in FIG. 12C), the first source gNB 110 may send a message to the second source gNB 130 and, in response, the second source gNB 130 sends an RRC reconfiguration message to the source relay UE 300 to release the sidelink wireless communications link between the remote UE 200 and the source relay UE 300. Alternatively, this procedure can be triggered by the remote UE 200.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein.

It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIoT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources. Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:
Paragraph 1. A method of operating a communications device to perform a multi-path handover from a source infrastructure equipment of a wireless communications network and a source relay communications device to a target infrastructure equipment of the wireless communications network and a target relay communications device, the method comprising
   receiving, from the source infrastructure equipment, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   determining, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met,
   transmitting the measurement report to the source infrastructure equipment, the measurement report comprising an indication of the one or more measurements of the quality of the wireless communications link between the communications device and the source infrastructure equipment and the one or more measurements of the quality of the wireless communications link between the communications device and the source relay communications device,
   receiving, from the source infrastructure equipment, an instruction to perform the multi-path handover from the source infrastructure equipment and source relay communications device to the target infrastructure equipment and target relay communications device, and
   performing the multi-path handover in accordance with the instruction received from the source infrastructure equipment.
Paragraph 2. A method according to paragraph 1, wherein the condition for triggering the communications device to transmit the measurement report is
   a condition that the measured quality of the wireless communications link between the communications device and the source infrastructure equipment is below a first predefined threshold and that the measured quality of the wireless communications link between the communications device and the source relay communications device is below a second pre-defined threshold.
Paragraph 3. A method according to paragraph 2, wherein the first pre-defined threshold and the second pre-defined threshold are the same.
Paragraph 4. A method according to any of paragraphs 1 to 3, wherein the determining that the condition has been met comprises
   receiving one or more reference signals over the wireless communications link between the communications device and the source infrastructure equipment, wherein
   the one or more measurements of the quality of the wireless communications link between the communications device and the source infrastructure equipment comprise one or more measurements of a signal quality of the reference signals received over the wireless communications link between the communications device and the source infrastructure equipment
Paragraph 5. A method according to paragraph 4, wherein the one or more measurements of the signal quality of the reference signals received over the wireless communications link between the communications device and the source infrastructure equipment comprise
   a reference signal received power, RSRP, of the one or more reference signals received over the wireless communications link between the communications device and the source infrastructure equipment.
Paragraph 6. A method according to any of paragraphs 4 to 5, wherein the one or more measurements of the signal quality of the reference signals received over the wireless communications link between the communications device and the source infrastructure equipment comprise
   a reference signal received quality, RSRQ, of the one or more reference signals received over the wireless communications link between the communications device and the source infrastructure equipment.
Paragraph 7. A method according to any of paragraphs 4 to 6, wherein the one or more measurements of the signal quality of the reference signals received over the wireless communications link between the communications device and the source infrastructure equipment comprise
   a signal to interference and noise ratio, SINR, of the one or more reference signals received over the wireless communications link between the communications device and the source infrastructure equipment.
Paragraph 8. A method according to any of paragraphs 1 to 7, wherein the determining that the condition has been met comprises
   receiving one or more reference signals over the wireless communications link between the communications device and the source relay communications device, wherein
   the one or more measurements of the quality of the wireless communications link between the communications device and the source relay communications device comprise one or more measurements of a signal quality of the reference signals received over the wireless communications link between the communications device and the source relay communications device.
Paragraph 9. A method according to paragraph 8, wherein the one or more measurements of the signal quality of the reference signals received over the wireless communications link between the communications device and the source relay communications device comprise
   a reference signal received power, RSRP, of the one or more reference signals received over the wireless communications link between the communications device and the source relay communications device.
Paragraph 10. A method according to paragraph 8 or paragraph 9, wherein the one or more measurements of the signal quality of the reference signals received over the wireless communications link between the communications device and the source relay communications device comprise
   a reference signal received quality, RSRQ, of the one or more reference signals received over the wireless communications link between the communications device and the source relay communications device.
Paragraph 11. A method according to any of paragraphs 8 to 10, wherein the one or more measurements of the signal quality of the reference signals received over the wireless communications link between the communications device and the source relay communications device comprise
   a signal to interference and noise ratio, SINR, of the one or more reference signals received over the wireless communications link between the communications device and the source relay communications device.
Paragraph 12. A method according to any of paragraphs 1 to 11, wherein the determining that the condition has been met comprises performing the one or more measurements of the quality of the wireless communications link between the communications device and the source infrastructure equipment.
Paragraph 13. A method according to any of paragraphs 1 to 12, wherein the determining that the condition has been met comprises performing the one or more measurements of the quality of the wireless communications link between the communications device and the source relay communications device.
Paragraph 14. A method according to any of paragraphs 1 to 13, wherein the receiving the instruction to perform the multi-path handover comprises
   receiving a configuration for a wireless communications link to be formed between the communications device and the target infrastructure equipment, and
   receiving a configuration for a wireless communications link to be formed between the communications device and the target relay communications device.
Paragraph 15. A method according to paragraph 14, wherein the configuration for the wireless communications link to be formed between the communications device and the target infrastructure equipment and the configuration for the wireless communications link between the communications device and the target relay communications device are received in the same message.
Paragraph 16. A method according to paragraph 15, wherein
   the configuration for the wireless communications link to be formed between the communications device and the target infrastructure equipment is a radio resource control, RRC, configuration,
   the configuration for the wireless communications link to be formed between the communications device and the target relay communications device is an RRC configuration, and
   the message is an RRC Reconfiguration message.
Paragraph 17. A method according to any of paragraphs 1 to 16, wherein the performing the multi-path handover comprises
   forming a wireless communications link between the communications device and the target infrastructure equipment.
Paragraph 18. A method according to paragraph 17, wherein the forming the wireless communications link between the communications device and the target infrastructure equipment comprises
   performing a random access channel, RACH, procedure with the target infrastructure equipment.
Paragraph 19. A method according to any of paragraphs 1 to 18, wherein the performing the multi-path handover comprises
   forming a wireless communications link between the communications device and the target relay communications device.
Paragraph 20. A method according to paragraph 19, wherein the forming the wireless communications link between the communications device and the target relay communications device comprises
   performing a PC5 connection establishment procedure with the target relay communications device.
Paragraph 21. A method according to any of paragraphs 1 to 20, wherein the performing the multipath handover comprises
   releasing the wireless communications link between the communications device and the source infrastructure equipment, and
   releasing the wireless communications link between the communications device and the source relay communications device.
Paragraph 22. A method according to any of paragraphs 1 to 21, wherein the performing the multipath handover comprises
   transmitting an indication to the target infrastructure equipment that the multi-path handover has been performed.
Paragraph 23. A method according to paragraph 22, wherein the transmitting the indication to the target infrastructure equipment that the multi-path handover has been performed comprises
   transmitting a Radio Resource Control, RRC, reconfiguration complete message to the target infrastructure equipment.
Paragraph 24. A method according to any of paragraphs 1 to 23, wherein the wireless communications link between the communications device and the source relay communications device is a PC5 communications link
Paragraph 25. A method according to any of paragraphs 1 to 24, wherein the wireless communications link between the communications device and the source infrastructure equipment is a Uu communications link.
Paragraph 26. A method according to any of paragraphs 1 to 25, wherein the measurement report comprises
   an indication of one or more measurements of a wireless communications link to be formed between the communications device and the target infrastructure equipment, and
   an indication of one or more measurements of a wireless communications link to be formed between the communications device and the target relay communications device.
Paragraph 27. A method according to 26, comprising
   performing the one or more measurements of the quality of the wireless communications link to be formed between the communications device and the target infrastructure equipment based on one or more reference signals received from the target infrastructure equipment, and
   performing the one or more measurements of the quality the wireless communications link to be formed between the communications device and the target infrastructure equipment based on one or more reference signals received from the target relay communications device.
Paragraph 28. A method of operating a source infrastructure equipment of a wireless communications network to control a multipath handover of a communications device from the source infrastructure equipment and a source relay communications device to a target infrastructure equipment of the wireless communications network and a target relay communications device, the method comprising
   transmitting, to the communications device, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   receiving the measurement report from the communications device, the measurement report comprising an indication of one or more measurements of the wireless communications link between the communications device and the source infrastructure equipment and one or more measurements of the wireless communications link between the communications device and the source relay communications device,
   determining, based on the measurement report received from the communications device, that the multipath handover should be performed, and
   transmitting an instruction to the communications device to perform the multipath handover.
Paragraph 29. A method according to paragraph 28, wherein the condition for triggering the communications device to transmit the measurement report is
   a condition that the measured quality of the wireless communications link between the communications device and the source infrastructure equipment is below a first predefined threshold and that the measured quality of the wireless communications link between the communications device and the source relay communications device is below a second pre-defined threshold.
Paragraph 30. A method according to paragraph 29, wherein the first pre-defined threshold and the second pre-defined threshold are the same.
Paragraph 31. A method according to any of paragraphs 28 to 30, comprising
   transmitting one or more reference signals over the wireless communications link between the communications device and the source infrastructure equipment.
Paragraph 32. A method according to any of paragraphs 28 to 31, wherein the target relay communications device is controlled by the target relay communications device, and the method comprises
   receiving, from the target infrastructure equipment, discovery information comprising an identification of the target relay communications device.
Paragraph 33. A method according to paragraph 32, wherein the determining that the multipath handover should be performed comprises determining that the multipath handover should be performed based on the measurement report and the discovery information.
Paragraph 34. A method according to any of paragraphs 28 to 33, comprising
   receiving, from the target infrastructure equipment, sidelink configuration information comprising a one or more of
   a PC5 Radio Link Control, RLC, channel configuration of a wireless communications link to be formed between the communications device and the target relay communications device, and
   a bearer configuration between the PC5 RLC and a Uu RLC of a wireless communications link between the target relay communications device and the target infrastructure equipment.
Paragraph 35. A method according to paragraph 34, wherein the wireless communications link between the target relay communications device and the target infrastructure equipment exists before the multipath handover.
Paragraph 36. A method according to paragraph 34 or paragraph 35, wherein the sidelink configuration is received over an X2 interface between the source infrastructure equipment and the target infrastructure equipment.
Paragraph 37. A method according to any of paragraphs 34 to 36, wherein the transmitting the instruction to perform the multi-path handover comprises
   determining a configuration for a wireless communications link to be formed between the communications device and the target infrastructure equipment,
   determining, based on the sidelink configuration information, a configuration for the wireless communications link to be formed between communications device and the target relay communications device, and
   transmitting, to the communications device, the configuration for the wireless communications link to be formed between the communications device and the target infrastructure equipment and the configuration for the wireless communications link to be formed between the communications device and the target relay communications device.
Paragraph 38. A method according to paragraph 37, wherein the configuration for the wireless communications link to be formed between the communications device and the target infrastructure equipment and the configuration for the wireless communications link to be formed between the communications device and the target relay communications device are transmitted in the same message.
Paragraph 39. A method according to paragraph 38, wherein
   the configuration for the wireless communications link to be formed between the communications device and the target infrastructure equipment is a radio resource control, RRC, configuration,
   the configuration for the wireless communications link to be formed between the communications device and the target relay communications device is an RRC configuration, and
   the message is an RRC Reconfiguration message.
Paragraph 40. A method according to any of paragraphs 28 to 38, wherein the wireless communications link between the communications device and the source relay communications device is a PC-5 communications link.
Paragraph 41. A method according to any of paragraphs 28 to 29, wherein the wireless communications link between the communications device and the source infrastructure equipment is a Uu communications link.
Paragraph 42. A method according to any of paragraphs 28 to 41, wherein the measurement report comprises
   an indication of one or more measurements of a wireless communications link to be formed between the communications device and the target infrastructure equipment, and
   an indication of one or more measurements of a wireless communications link to be formed between the communications device and the target relay communications device.
Paragraph 43. A method of operating a communications device to form a multipath connection to a first infrastructure equipment of a wireless communications network and a relay communications device controlled by a second infrastructure equipment of the wireless communications network, the method comprising
   receiving, from the first infrastructure equipment over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   determining, based on one or more measurements of the quality of the wireless communications link to be formed between the communications device and the relay communications device, that the condition for triggering the communications device to transmit the measurement report has been met,
   transmitting the measurement report to the first infrastructure equipment, the measurement report comprising an indication of the one or more measurements of the quality of the wireless communications link to be formed between the communications device and the relay communications device,
   receiving, from the first infrastructure equipment, an instruction to form the wireless communications link with the relay communications device, and
   forming the wireless communications link with the relay communications device.
Paragraph 44. A method according to paragraph 43, wherein the condition for triggering the communications device to transmit the measurement report is
   a condition that the one or more measurements of the quality of the wireless communications link to be formed between the communications device and the relay communications device is above a predefined threshold.
Paragraph 45. A method according to paragraph 43 or paragraph 44, wherein the determining that the condition has been met comprises
   receiving one or more reference signals from the relay communications device, wherein
   the one or more measurements of the quality of the wireless communications link to be formed2 between the communications device and the relay communications device is based on one or more measurements of a signal quality of the reference signals received from the relay communications device.
Paragraph 46. A method according to paragraph 45, wherein the one or more measurements of the signal quality of the reference signals comprise
   a reference signal received power, RSRP, of the one or more reference signals.
Paragraph 47. A method according to any of paragraphs 43 to 46, wherein the one or more measurements of the signal quality of the reference signals comprise
   a reference signal received quality, RSRQ, of the one or more reference signals.
Paragraph 48. A method according to any of paragraphs 43 to 47, wherein the one or more measurements of the signal quality of the reference signals comprise
   a signal to interference and noise ratio, SINR, of the one or more reference signals.
Paragraph 49. A method according to any of paragraphs 43 to 48, wherein the determining that the condition has been met comprises performing the one or more measurements of the quality of the wireless communications link to be formed between the communications device and the relay communications device.
Paragraph 50. A method according to any of paragraphs 43 to 50, wherein the receiving the instruction to form the wireless communications link with the relay communications device comprises
   receiving, from the first infrastructure equipment, a configuration for the wireless communications link to be formed between the communications device and the relay communications device.
Paragraph 51. A method according to paragraph 50, wherein the receiving the configuration for the wireless communications link to be formed between the communications device and the relay communications device comprises
   receiving a Radio Resource Control, RRC, reconfiguration message from the first infrastructure equipment, the RRC reconfiguration message comprising an RRC configuration for the wireless communications link to be formed between the communications device and the relay communications device.
Paragraph 52. A method according to any of paragraphs 43 to 51, wherein the forming the wireless communications link with the relay communications device comprises
   performing a PC5 connection establishment procedure with the relay communications device.
Paragraph 53. A method according to any of paragraphs 43 to 52, comprising
   transmitting an indication to the first infrastructure equipment that the multipath connection set up has been performed.
Paragraph 54. A method according to paragraph 53, wherein the transmitting the indication to the first infrastructure equipment that the multipath connection setup has been performed comprises
   transmitting a Radio Resource Control, RRC, reconfiguration complete message to the first infrastructure equipment.
Paragraph 55. A method of operating a first infrastructure equipment of a wireless communications network to control a communications device to form a multipath connection to the first infrastructure equipment and a relay communications device controlled by a second infrastructure equipment of the wireless communications network, the method comprising
   transmitting, to the communications device over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   receiving the measurement report from the communications device, the measurement report comprising an indication of one or more measurements of the quality of the wireless communications link to be formed between the communications device and the relay communications device,
   transmitting, to the communications device, an instruction to form the wireless communications link with the relay communications device.
Paragraph 56. A method according to paragraph 55, wherein the condition for triggering the communications device to transmit the measurement report is
   a condition that the one or more measurements of the quality of the wireless communications link to be formed between the communications device and the relay communications device is above a predefined threshold.
Paragraph 57. A method according to paragraph 55 or paragraph 56, comprising
   receiving, from the second infrastructure equipment, discovery information comprising an identification of the relay communications device.
Paragraph 58. A method according to paragraph 57, wherein the determining that the multipath handover should be performed comprises determining that the multipath connection setup should be performed based on the measurement report and the discovery information.
Paragraph 59. A method according to any of paragraphs 55 to 59, comprising
   transmitting, to the second infrastructure equipment, a request for a configuration of the wireless communications link to be formed between the communications device and the relay communications device, and
   receiving, from the second infrastructure equipment, the configuration of the wireless communications link to be formed between the communications device and the relay communications device.
Paragraph 60. A method according to paragraph 59, comprising
   determining a Radio Resource Control, RRC, configuration for the wireless communications link to be formed between the communications device and the relay communications device
   transmitting the RRC configuration to the communications device in an RRC message.
Paragraph 61. A method according to any of paragraphs 55 to 60, comprising
   receiving an indication from the communications device that the multipath connection set up has been performed.
Paragraph 62. A method according to paragraph 61, wherein the receiving the indication from the communications device that the multipath connection setup has been performed comprises
   receiving a Radio Resource Control, RRC, reconfiguration complete message from the communications device.
Paragraph 63. A communications device operable to perform a multi-path handover from a source infrastructure equipment of a wireless communications network and a source relay communications device to a target infrastructure equipment of the wireless communications network and a target relay communications device, the communications device comprising
   a transmitter configured to transmit signals,
   a receiver configured to receive signals,
   a controller configured in combination with the transmitter and the receiver to
   receive, from the source infrastructure equipment, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   determine, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met,
   transmit the measurement report to the source infrastructure equipment, the measurement report comprising an indication of the one or more measurements of the quality of the wireless communications link between the communications device and the source infrastructure equipment and the one or more measurements of the quality of the wireless communications link between the communications device and the source relay communications device,
   receive, from the source infrastructure equipment, an instruction to perform the multi-path handover from the source infrastructure equipment and source relay communications device to the target infrastructure equipment and target relay communications device, and
   perform the multi-path handover in accordance with the instruction received from the source infrastructure equipment.
Paragraph 64. A source infrastructure equipment of a wireless communications network operable to control a multipath handover of a communications device from the source infrastructure equipment and a source relay communications device to a target infrastructure equipment of the wireless communications network and a target relay communications device, the source infrastructure equipment comprising
   a transmitter configured to transmit signals,
   a receiver configured to receive signals,
   a controller configured in combination with the transmitter and the receiver to
   transmit, to the communications device, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   receive the measurement report from the communications device, the measurement report comprising an indication of one or more measurements of the wireless communications link between the communications device and the source infrastructure equipment and one or more measurements of the wireless communications link between the communications device and the source relay communications device,
   determine, based on the measurement report received from the communications device, that the multipath handover should be performed, and
   transmit an instruction to the communications device to perform the multipath handover.
Paragraph 65. A communications device operable to form a multipath connection to a first infrastructure equipment of a wireless communications network and a relay communications device controlled by a second infrastructure equipment of the wireless communications network, the communications device comprising
   a transmitter configured to transmit signals,
   a receiver configured to receive signals,
   a controller configured in combination with the transmitter and the receiver to
   receive, from the first infrastructure equipment over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   determine, based on one or more measurements of the quality of the wireless communications link to be formed between the communications device and the relay communications device, that the condition for triggering the communications device to transmit the measurement report has been met,
   transmit the measurement report to the first infrastructure equipment, the measurement report comprising an indication of the one or more measurements of the quality of the wireless communications link to be formed between the communications device and the relay communications device,
   receive, from the first infrastructure equipment, an instruction to form the wireless communications link with the relay communications device, and
   form the wireless communications link with the relay communications device.
Paragraph 66. A first infrastructure equipment of a wireless communications network operable to control a communications device to form a multipath connection to the first infrastructure equipment and a relay communications device controlled by a second infrastructure equipment of the wireless communications network, the first infrastructure equipment comprising
   a transmitter configured to transmit signals,
   a receiver configured to receive signals,
   a controller configured in combination with the transmitter and the receiver to
   transmit, to the communications device over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   receive the measurement report from the communications device, the measurement report comprising an indication of one or more measurements of the quality of the wireless communications link to be formed between the communications device and the relay communications device,
   transmit, to the communications device, an instruction to form the wireless communications link with the relay communications device.
Paragraph 67. Circuitry for a communications device operable to perform a multi-path handover from a source infrastructure equipment of a wireless communications network and a source relay communications device to a target infrastructure equipment of the wireless communications network and a target relay communications device, the circuitry comprising
   transmitter circuitry configured to transmit signals,
   receiver circuitry configured to receive signals,
   controller circuitry configured in combination with the transmitter circuitry and the receiver circuitry to
   receive, from the source infrastructure equipment, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   determine, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met,
   transmit the measurement report to the source infrastructure equipment, the measurement report comprising an indication of the one or more measurements of the quality of the wireless communications link between the communications device and the source infrastructure equipment and the one or more measurements of the quality of the wireless communications link between the communications device and the source relay communications device,
   receive, from the source infrastructure equipment, an instruction to perform the multi-path handover from the source infrastructure equipment and source relay communications device to the target infrastructure equipment and target relay communications device, and
   perform the multi-path handover in accordance with the instruction received from the source infrastructure equipment.
Paragraph 68. Circuitry for a source infrastructure equipment of a wireless communications network operable to control a multipath handover of a communications device from the source infrastructure equipment and a source relay communications device to a target infrastructure equipment of the wireless communications network and a target relay communications device, the circuitry comprising
   transmitter circuitry configured to transmit signals,
   receiver circuitry configured to receive signals,
   controller circuitry configured in combination with the transmitter circuitry and the receiver circuitry to
   transmit, to the communications device, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
   receive the measurement report from the communications device, the measurement report comprising an indication of one or more measurements of the wireless communications link between the communications device and the source infrastructure equipment and one or more measurements of the wireless communications link between the communications device and the source relay communications device,
   determine, based on the measurement report received from the communications device, that the multipath handover should be performed, and
   transmit an instruction to the communications device to perform the multipath handover.
Paragraph 69. Circuitry for a communications device operable to form a multipath connection to a first infrastructure equipment of a wireless communications network and a relay communications device controlled by a second infrastructure equipment of the wireless communications network, the circuitry comprising
   transmitter circuitry configured to transmit signals,
   receiver circuitry configured to receive signals,
   controller circuitry configured in combination with the transmitter circuitry and the receiver circuitry to
   receive, from the first infrastructure equipment over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   determine, based on one or more measurements of the quality of the wireless communications link to be formed between the communications device and the relay communications device, that the condition for triggering the communications device to transmit the measurement report has been met,
   transmit the measurement report to the first infrastructure equipment, the measurement report comprising an indication of the one or more measurements of the quality of the wireless communications link to be formed between the communications device and the relay communications device,
   receive, from the first infrastructure equipment, an instruction to form the wireless communications link with the relay communications device, and
   form the wireless communications link with the relay communications device.
Paragraph 70. Circuitry for a first infrastructure equipment of a wireless communications network operable to control a communications device to form a multipath connection to the first infrastructure equipment and a relay communications device controlled by a second infrastructure equipment of the wireless communications network, the circuitry comprising
   transmitter circuitry configured to transmit signals,
   receiver circuitry configured to receive signals,
   controller circuitry configured in combination with the transmitter circuitry and the receiver circuitry to
   transmit, to the communications device over a wireless communications link between the communications device and the first infrastructure equipment, a measurement configuration comprising a condition for triggering the communications device to transmit a measurement report to the first infrastructure equipment, the condition being based on a quality of a wireless communications link to be formed between the communications device and the relay communications device,
   receive the measurement report from the communications device, the measurement report comprising an indication of one or more measurements of the quality of the wireless communications link to be formed between the communications device and the relay communications device,
   transmit, to the communications device, an instruction to form the wireless communications link with the relay communications device.
Paragraph 71. A wireless communications network comprising a communications device according to paragraph 63 and a source infrastructure equipment according to paragraph 64.
Paragraph 72. A wireless communications network comprising a communications device according to paragraph 65 and a first infrastructure equipment according to paragraph 66.
Paragraph 73. A computer program comprising instructions which, when loaded onto a computer, cause the computer to perform a method according to any of paragraphs 1 to 62.
Paragraph 74. A non-transitory computer-readable storage medium storing a computer program according to paragraph 73.

### REFERENCES

[1] Holma H. and Toskala A, “LTE for UMTS OFDMA and SC-FDMA based radio access”, John Wiley and Sons, 2009.
[2] RP-192330, “New work item: 2-step RACH for NR,” ZTE Corporation, 3GPP TSG RAN Meeting #85.
[3] RP-192324, “Revised WID: Support of NR Industrial Internet of Things (IoT),” Nokia, Nokia Shanghai Bell, 3GPP TSG RAN Meeting #85.
[4] RP-191575, “NR-based Access to Unlicensed Spectrum,” Qualcomm, Inc., 3GPP TSG RAN Meeting #84.

1. A method of operating a communications device to perform a multi-path handover from a source infrastructure equipment of a wireless communications network and a source relay communications device to a target infrastructure equipment of the wireless communications network and a target relay communications device, the method comprising
receiving, from the source infrastructure equipment, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
determining, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met,
transmitting the measurement report to the source infrastructure equipment, the measurement report comprising an indication of the one or more measurements of the quality of the wireless communications link between the communications device and the source infrastructure equipment and the one or more measurements of the quality of the wireless communications link between the communications device and the source relay communications device,
receiving, from the source infrastructure equipment, an instruction to perform the multi-path handover from the source infrastructure equipment and source relay communications device to the target infrastructure equipment and target relay communications device, and
performing the multi-path handover in accordance with the instruction received from the source infrastructure equipment.

2. A method according to claim 1, wherein the condition for triggering the communications device to transmit the measurement report is
a condition that the measured quality of the wireless communications link between the communications device and the source infrastructure equipment is below a first predefined threshold and that the measured quality of the wireless communications link between the communications device and the source relay communications device is below a second pre-defined threshold.

3. A method according to claim 2, wherein the first pre-defined threshold and the second pre-defined threshold are the same.

4. A method according to claim 1, wherein the determining that the condition has been met comprises
receiving one or more reference signals over the wireless communications link between the communications device and the source infrastructure equipment, wherein
the one or more measurements of the quality of the wireless communications link between the communications device and the source infrastructure equipment comprise one or more measurements of a signal quality of the reference signals received over the wireless communications link between the communications device and the source infrastructure equipment

5. A method according to claim 4, wherein the one or more measurements of the signal quality of the reference signals received over the wireless communications link between the communications device and the source infrastructure equipment comprise
a reference signal received power, RSRP, of the one or more reference signals received over the wireless communications link between the communications device and the source infrastructure equipment.

6. A method according to claim 4, wherein the one or more measurements of the signal quality of the reference signals received over the wireless communications link between the communications device and the source infrastructure equipment comprise
a reference signal received quality, RSRQ, of the one or more reference signals received over the wireless communications link between the communications device and the source infrastructure equipment.

7. A method according to claim 4, wherein the one or more measurements of the signal quality of the reference signals received over the wireless communications link between the communications device and the source infrastructure equipment comprise
a signal to interference and noise ratio, SINR, of the one or more reference signals received over the wireless communications link between the communications device and the source infrastructure equipment.

8. A method according to claim 1, wherein the determining that the condition has been met comprises
receiving one or more reference signals over the wireless communications link between the communications device and the source relay communications device, wherein
the one or more measurements of the quality of the wireless communications link between the communications device and the source relay communications device comprise one or more measurements of a signal quality of the reference signals received over the wireless communications link between the communications device and the source relay communications device.

9. A method according to claim 8, wherein the one or more measurements of the signal quality of the reference signals received over the wireless communications link between the communications device and the source relay communications device comprise
a reference signal received power, RSRP, of the one or more reference signals received over the wireless communications link between the communications device and the source relay communications device.

10. A method according to claim 8, wherein the one or more measurements of the signal quality of the reference signals received over the wireless communications link between the communications device and the source relay communications device comprise
a reference signal received quality, RSRQ, of the one or more reference signals received over the wireless communications link between the communications device and the source relay communications device.

11. A method according to claim 8, wherein the one or more measurements of the signal quality of the reference signals received over the wireless communications link between the communications device and the source relay communications device comprise
a signal to interference and noise ratio, SINR, of the one or more reference signals received over the wireless communications link between the communications device and the source relay communications device.

12. A method according to claim 1, wherein the determining that the condition has been met comprises performing the one or more measurements of the quality of the wireless communications link between the communications device and the source infrastructure equipment.

13. A method according to claim 1, wherein the determining that the condition has been met comprises performing the one or more measurements of the quality of the wireless communications link between the communications device and the source relay communications device.

14. A method according to claim 1, wherein the receiving the instruction to perform the multi-path handover comprises
receiving a configuration for a wireless communications link to be formed between the communications device and the target infrastructure equipment, and
receiving a configuration for a wireless communications link to be formed between the communications device and the target relay communications device.

15. A method according to claim 14, wherein the configuration for the wireless communications link to be formed between the communications device and the target infrastructure equipment and the configuration for the wireless communications link between the communications device and the target relay communications device are received in the same message.

16. A method according to claim 15, wherein
the configuration for the wireless communications link to be formed between the communications device and the target infrastructure equipment is a radio resource control, RRC, configuration,
the configuration for the wireless communications link to be formed between the communications device and the target relay communications device is an RRC configuration, and
the message is an RRC Reconfiguration message.

17. A method according to claim 1, wherein the performing the multi-path handover comprises
forming a wireless communications link between the communications device and the target infrastructure equipment.

18. (canceled)

19. A method according to claim 1, wherein the performing the multi-path handover comprises
forming a wireless communications link between the communications device and the target relay communications device.

20.-62. (canceled)

63. A communications device operable to perform a multi-path handover from a source infrastructure equipment of a wireless communications network and a source relay communications device to a target infrastructure equipment of the wireless communications network and a target relay communications device, the communications device comprising
a transmitter configured to transmit signals,
a receiver configured to receive signals,
a controller configured in combination with the transmitter and the receiver to
receive, from the source infrastructure equipment, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
determine, based on one or more measurements of the quality of the wireless communications link between the communications device and the source infrastructure equipment and one or more measurements of the quality of the wireless communications link between the communications device and the source relay communications device, that the condition for triggering the communications device to transmit the measurement report has been met,
transmit the measurement report to the source infrastructure equipment, the measurement report comprising an indication of the one or more measurements of the quality of the wireless communications link between the communications device and the source infrastructure equipment and the one or more measurements of the quality of the wireless communications link between the communications device and the source relay communications device,
receive, from the source infrastructure equipment, an instruction to perform the multi-path handover from the source infrastructure equipment and source relay communications device to the target infrastructure equipment and target relay communications device, and
perform the multi-path handover in accordance with the instruction received from the source infrastructure equipment.

64. A source infrastructure equipment of a wireless communications network operable to control a multipath handover of a communications device from the source infrastructure equipment and a source relay communications device to a target infrastructure equipment of the wireless communications network and a target relay communications device, the source infrastructure equipment comprising
a transmitter configured to transmit signals,
a receiver configured to receive signals,
a controller configured in combination with the transmitter and the receiver to
transmit, to the communications device, a measurement configuration comprising a condition for triggering the communications device to transmit a measurement report to the source infrastructure equipment, the condition being based on a quality of a wireless communications link between the communications device and the source infrastructure equipment and a quality of a wireless communications link between the communications device and the source relay communications device,
receive the measurement report from the communications device, the measurement report comprising an indication of one or more measurements of the wireless communications link between the communications device and the source infrastructure equipment and one or more measurements of the wireless communications link between the communications device and the source relay communications device,
determine, based on the measurement report received from the communications device, that the multipath handover should be performed, and
transmit an instruction to the communications device to perform the multipath handover.

65.-74. (canceled)
